(19) United States
(12) Patent Application Publication
(10) Pub. No.: US 2024/0394663 A1
(43) Pub. Date: Nov. 28, 2024

(54) MATCHING SYSTEM, RECRUITER APPARATUS, AND METHOD

(71) Applicant: Murata Manufacturing Co., Ltd., Kyoto-fu (JP)

(72) Inventors: Masaharu ITAYA, Nagaokakyo-shi (JP); Yusuke MORI, Nagaokakyo-shi (JP); Yuuto NIWA, Nagaokakyo-shi (JP); Kazuki MATSUI, Nagaokakyo-shi (JP)

(21) Appl. No.: 18/793,000

(22) Filed: Aug. 2, 2024

Related U.S. Application Data
(63) Continuation of application No. PCT/JP2023/002428, filed on Jan. 26, 2023.

(30) Foreign Application Priority Data
Feb. 4, 2022 (JP) 2022-016305
Jul. 29, 2022 (JP) 2022-121310

(51) Int. Cl. G06Q 10/1053

(52) U.S. Cl. CPC G06Q 10/1053

(57) ABSTRACT

A matching system that matches an applicant with a recruiter who recruits a vendor for a business, the matching system includes: a first applicant apparatus that is operated by a first applicant; and a computing apparatus that can communicate with the first applicant apparatus and can access a database, in which the computing apparatus can register, in the database, business information for recruiting the vendor and disclosure information indicating a disclosure range of the business information, and the computing apparatus can determine, based on the disclosure information, business information allowed to be disclosed to the first applicant among the business information registered in the database and can provide the business information allowed to be disclosed to the first applicant to the first applicant apparatus.

### CROSS REFERENCE TO RELATED APPLICATION

This is a continuation of International Application No. PCT/JP2023/002428 filed on Jan. 26, 2023 which claims priority from Japanese Patent Application No. 2022-016305 filed on Feb. 4, 2022 and Japanese Patent Application No. 2022-121310 filed on Jul. 29, 2022. The contents of these applications are incorporated herein by reference in their entireties.

### BACKGROUND ART

The present disclosure relates to a matching system, a recruiter apparatus, and a method for matching an applicant with a recruiter who recruits a vendor for a business.

In the past, crowdsourcing has been leveraged in enterprises and the like. Crowdsourcing is generally the process of recruiting the contributions of an unspecified number of people to obtain a service, idea, or content. In crowdsourcing, it is desirable to find a human resource having an optimal capability for a requested business.

Japanese Patent Laid-Open No. 2003-4462 (PTL 1) describes a method of comparing to check whether information on a human resource for a development project matches information on a member of an enterprise, and extracting members who match the human resource from all organizations of the enterprise as a search result.

### BRIEF SUMMARY

The crowdsourcing described in PTL 1 is performed in one group called enterprise. However, it is desirable to further broaden the scope of crowdsourcing in order to find more appropriate human resources. In this case, it is desired to consider the interest relation between the recruiter who recruits the vendor for the business and the applicant who applies for the recruitment.

The present disclosure provides a solution for the above-described problem, and the present disclosure enables selection of an appropriate applicant in consideration of the interest relation between the recruiter and the applicant.

A matching system according to a first aspect of the present disclosure matches an applicant with a recruiter who recruits a vendor for a business, the matching system including: a first applicant apparatus that is operated by a first applicant; and a computing apparatus that is configured to communicate with the first applicant apparatus and to access to a database, wherein the computing apparatus is configured to register, in the database, business information for recruiting the vendor and disclosure information indicating a disclosure range of the business information, the computing apparatus is configured to determine, based on the disclosure information, business information allowed to be disclosed to the first applicant among the business information registered in the database and to provide the business information allowed to be disclosed to the first applicant to the first applicant apparatus, in a case where the computing apparatus is configured to receive an input of recruitment form information, the computing apparatus is configured to register the recruitment form information in the database in association with the business information, the recruitment form information being used to identify whether a business for which the vendor is recruited is a group business for which an order is acceptable when a plurality of applicants jointly apply or a business for which an order is acceptable in response to an application by a single applicant, the computing apparatus is configured to register an application group constituted of a plurality of applicants in the database, and the computing apparatus is configured to receive an application by the application group for business information that is allowed to be disclosed to all applicants belonging to the application group.

A recruiter apparatus according to a second aspect of the present disclosure communicates with a computing apparatus that matches an applicant with a recruiter who recruits a vendor for a business and is operated by the recruiter, the recruiter apparatus including: an interface that receives an operation of inputting business information and disclosure information indicating a disclosure range of the business information; and a processor that transmits to the computing apparatus, the business information and the disclosure information received by the interface, wherein the disclosure information includes information that commands the computing apparatus to allow disclosure of the business information to a first applicant and to prohibit disclosure of the business information to a second applicant different from the first applicant, in a case where the computing apparatus is configured to receive an input of recruitment form information, the computing apparatus is configured to register the recruitment form information in the database in association with the business information, the recruitment form information being used to identify whether a business for which the vendor is recruited is a group business for which an order is acceptable when a plurality of applicants jointly apply or a business for which an order is acceptable in response to an application by a single applicant, the computing apparatus registers an application group constituted of a plurality of applicants in the database, and the computing apparatus is configured to receive an application by the application group for business information that is allowed to be disclosed to all applicants belonging to the application group.

A method according to a third aspect of the present disclosure is for matching an applicant with a recruiter who recruits a vendor for a business, the method including: communicating with a first applicant apparatus operated by a first applicant; registering business information for recruiting the vendor and disclosure information indicating a disclosure range of the business information in a database; determining, based on the disclosure information, business information allowed to be disclosed to the first applicant among the business information registered in the database to provide the business information allowed to be disclosed to the first applicant to the first applicant apparatus; registering recruitment form information in the database in association with the business information, when an input of the recruitment form information is received, the recruitment form information being used to identify whether a business for which the vendor is recruited is a group business for which an order is acceptable when a plurality of applicants jointly apply or a business for which an order is acceptable in response to an application by a single applicant; registering an application group constituted of a plurality of applicants in the database; and receiving an application by the application group for business information that is allowed to be disclosed to all applicants belonging to the application group.

According to the present disclosure, it is possible to select an appropriate applicant in consideration of an interest relation between a recruiter who recruits a vendor for a business and an applicant who applies for the recruitment.

### BRIEF DESCRIPTION OF DRAWINGS

FIG. 1 is a block diagram illustrating an outline of a matching system.

FIG. 2 is a block diagram illustrating a configuration of a sharing server, a recruiter apparatus, and an applicant apparatus.

FIG. 3 is a diagram illustrating an example of an enterprise database.

FIG. 4 is a diagram illustrating an example of a member database.

FIG. 5 is a diagram illustrating an example of a community database.

FIG. 6 is a diagram illustrating an example of a recruitment case database.

FIG. 7 is a diagram illustrating an example of a sideline database.

FIG. 8 is a diagram illustrating an example of an evaluation input database.

FIG. 9 is a diagram illustrating an example of an evaluation summary database.

FIG. 10 is a diagram illustrating functions of the sharing server, the recruiter apparatus, and the applicant apparatus.

FIG. 11 is a diagram illustrating functions of the sharing server, the recruiter apparatus, and the applicant apparatus.

FIG. 12 is a diagram illustrating functions of the sharing server, the recruiter apparatus, and the applicant apparatus.

FIG. 13 is a diagram illustrating a procedure of registering a recruitment case in the recruitment case database.

FIG. 14 is a diagram illustrating a procedure of searching for a recruitment case from a database.

FIG. 15 is a diagram illustrating a procedure of registering a schedule and an achievement of a sideline in a database.

FIG. 16 is a diagram illustrating a procedure of registering an evaluation of an applicant in a database.

FIG. 17 is a diagram illustrating a procedure of displaying an evaluation of an applicant and a search result of a member on a display.

FIG. 18 is a diagram illustrating a browsable range of the evaluation summary database.

FIG. 19 is a diagram illustrating an example of a disclosure range is set in accordance with a disclosure level.

FIG. 20 is a diagram illustrating a screen displayed on an applicant apparatus of a manager when the manager (a superior of an applicant) checks a subordinate's sideline status.

FIG. 21 is a diagram illustrating functions of a sharing server, a recruiter apparatus, and an applicant apparatus according to Modification 1.

FIG. 22 is a diagram illustrating an example of a member database according to Modification 1.

FIG. 23 is a flowchart illustrating a processing procedure of a reverse offer member search process according to Modification 1.

FIG. 24 is a block diagram illustrating a configuration of a sharing server, a recruiter apparatus, and an applicant apparatus according to Modification 2.

FIG. 25 is a diagram illustrating an example of a member group database according to Modification 2.

FIG. 26 is a diagram illustrating an example of a recruitment case database according to Modification 2.

FIG. 27 is a diagram illustrating functions of the sharing server, the recruiter apparatus, and the applicant apparatus according to Modification 2.

FIG. 28 is a diagram illustrating a procedure of registering a recruitment case in the recruitment case database according to Modification 2.

FIG. 29 is a diagram illustrating a configuration of a matching system according to Modification 3.

FIG. 30 is a diagram illustrating an example (Modification 4) of applying Kerberos authentication to the matching system.

### DETAILED DESCRIPTION

Hereinafter, embodiments of the present disclosure will be described in detail with reference to the drawings. Note that the same or corresponding parts in the drawings are denoted by the same reference signs, and description thereof will not be repeated.

### Background of Proposing Matching System

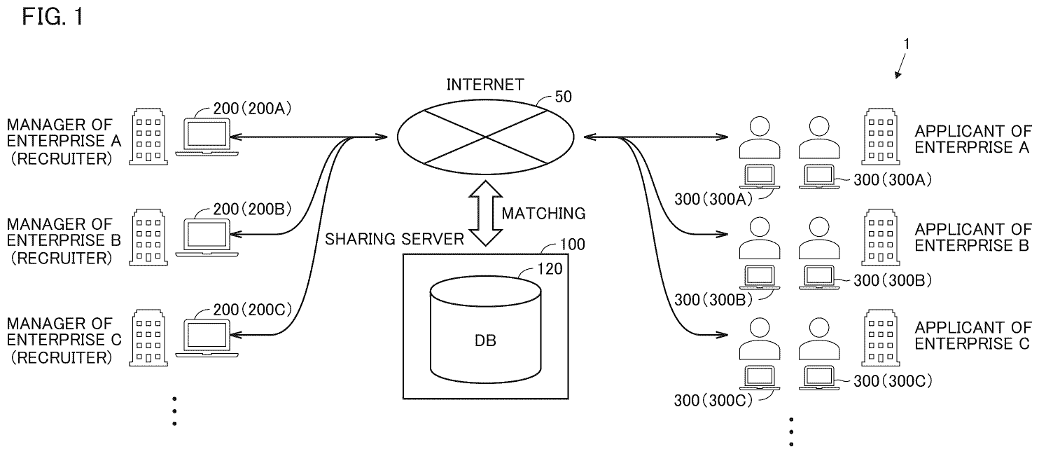

FIG. 1 is a block diagram illustrating an overview of a matching system 1 according to the present embodiment. First, a background of proposing matching system 1 according to the present embodiment will be described.

Matching system 1 is leveraged for, for example, crowdsourcing among enterprises. Crowdsourcing is generally the process of recruiting the contributions of an unspecified number of people to obtain a service, idea, or content.

Many enterprises are promoting sideline (e.g., side work, side career, etc.) to effectively leverage human resources. By utilizing crowdsourcing among enterprises, the capabilities of the employees of the enterprises can be leveraged.

However, when a general crowdsourcing method is applied among enterprises as it is, the following problem may occur.

### Possibility of Confidential Information Leakage

In a general crowdsourcing method, a relation between an enterprise on a purchaser side and an enterprise on a vendor side is not considered, and thus adopting crowdsourcing involves enterprise risk and individual risk. For example, confidential information may be leaked to an enterprise in a rival relation through a sideline of an employee. A manager cannot check that an employee does not accept an order for a case of a competitor as a sideline in a conventional crowdsourcing method.

### Possibility of Overwork

When an enterprise allows an employee to do a sideline, the employee's working hours may be excessively long. It is conceivable that in order to eliminate the risk of overwork, an enterprise determines the upper limit of overtime hours including main business hours and sideline hours. However, as long as the employee can freely accept an order for a sideline, it is difficult for the enterprise to manage the sideline hours of the employee. As a result, the employee may be overworked.

Possibility that Outcome of Sideline is not Duly Evaluated

Conventionally, there is a crowdsourcing system that requests a purchaser to evaluate a vendor. When the appropriate evaluation made by the purchaser is shared by the crowdsourcing system, the person who recruits a vendor for a business can select a person with high capability from among many persons who desire to accept an order for the business with reference to the evaluation.

However, a purchaser of a certain enterprise may input a higher evaluation than the original evaluation to the system because the purchaser is concerned about a vendor of another enterprise to be evaluated. Further, a purchaser of a certain enterprise may avoid evaluating a vendor of another enterprise low in consideration of the possibility that the relation among enterprises may be deteriorated. Further, the purchaser may not feel a merit in making an evaluation, and may input an evaluation far from the original evaluation to the system. In view of these possibilities, the reliability of evaluations provided by the system may be reduced. In this case, even if the evaluation of vendors is shared, the purchaser of the business cannot leverage the evaluation as reference data when selecting a vendor.

### Specialization Regarding Determination of Enterprise as Subject of Matching

In general, in order to match human resources and business across enterprises, enterprises matching human resources and business should have a close relation such as a trust relation. Therefore, for example, it is very difficult to match human resources and business among enterprises having no capital relation. In addition, a large enterprise such as a listed enterprise is likely to compete with other enterprises from the viewpoint of diversification or the like, and cannibalization occurs between the large enterprise and other enterprises. Therefore, there is a special situation in which human resources and business cannot be matched among a large number of enterprises.

According to the present embodiment, matching system 1 described in detail below is proposed for the purpose of solving at least one of the above-described various problems of conventional crowdsourcing.

### Overall Configuration

The overview configuration of matching system 1 will be described with reference to FIG. 1. Matching system 1 includes a sharing server 100, recruiter apparatuses 200A, 200B, 200C . . . , and applicant apparatuses 300A, 300B, 300C . . . .

Sharing server 100 provides a matching service for matching orders and order acceptances of business among enterprises to a large number of enterprises. In FIG. 1, an enterprise A, an enterprise B, an enterprise C . . . are illustrated as examples of enterprises that utilize the matching service. Enterprise A, enterprise B, enterprise C . . . are registered as enterprise members of matching system 1. Among employees of enterprise A, enterprise B, enterprise C . . . , persons who utilize matching system 1 are also individually registered as members of matching system 1.

The business to be mediated in matching system 1 is, for example, a temporary business that is expected to be completed within a predetermined period. Therefore, a person who accepts an order for a business to be mediated in matching system 1 is engaged in each business, with the business in a specific department to which the person belongs in the enterprise as a main business and the business to be mediated in matching system 1 as a sideline. In matching system 1, for example, an applicant of enterprise A can also accept an order for a business of enterprise A. Therefore, in matching system 1, an applicant belonging to a different department Y of enterprise A is allowed to accept an order for a business of a department X of enterprise A.

Hereinafter, the business in which the vendor is recruited in matching system 1 may be referred to as “recruitment business” or “recruitment case”, a person who provides the recruitment case may be referred to as “recruiter”, and a person who applies for the order of the recruitment case may be referred to as “applicant”. Applying for the recruitment business may be referred to as “application for the recruitment business” or “application for the recruitment case.”

The applicant who has received the order for the recruitment case corresponds to the “vendor”, and the recruiter who has ordered the case from the vendor corresponds to the “purchaser”. Hereinafter, “applicant” may include “vendor”, and “recruiter” may include “purchaser.”

A database 120 for the matching service is constructed in sharing server 100. Database 120 may include various databases in which information for providing the matching service is registered. For example, information, etc. on members and recruitment business are registered in database 120. Sharing server 100 is managed and operated by an enterprise different from an enterprise that utilizes the matching service. Any enterprise that utilizes the matching service may manage and operate sharing server 100.

Recruiter apparatus 200A is operated by a manager of enterprise A. Recruiter apparatus 200B is operated by a manager of enterprise B. Recruiter apparatus 200C is operated by a manager of enterprise C. Hereinafter, recruiter apparatuses 200A, 200B, 200C . . . may be collectively referred to as “recruiter apparatus 200”.

Applicant apparatus 300A is operated by an applicant of enterprise A. Applicant apparatus 300B is operated by an applicant of enterprise B. Applicant apparatus 300C is operated by an applicant of enterprise C. Hereinafter, applicant apparatuses 300A, 300B, 300C . . . may be collectively referred to as “applicant apparatus 300”. Although two applicants are illustrated for each enterprise in FIG. 1, the number of applicants is not limited to this. There may be more applicants in each enterprise, or there may be one applicant in an enterprise. Sharing server 100 may accept a person who does not belong to the enterprise such as freelance as an applicant.

The managers of enterprise A, enterprise B, enterprise C . . . are assumed to serve as recruiters according to the present embodiment. Therefore, hereinafter, the manager of each enterprise may be referred to as “recruiter”. The recruiter can also act as an applicant for a business that another recruiter is recruiting. In this case, recruiter apparatus 200 functions as applicant apparatus 300. According to the present embodiment, when a manager of an enterprise acts as a recruiter, the apparatus used by the manager to utilize the matching service is referred to as recruiter apparatus 200.

The number of managers of enterprise A may be one or more. When managers are arranged in enterprise A, recruiter apparatus 200 may be provided to each manager, or one recruiter apparatus 200 may be shared by a plurality of persons. The same applies to enterprise B, enterprise C . . . .

Sharing server 100 and recruiter apparatus 200 are configured to be able to communicate with each other via an internet 50 which is an example of a communication network. Sharing server 100 and applicant apparatus 300 are configured to be able to communicate with each other via internet 50.

Sharing server 100 requests sign-in accompanied by input of a member ID and a password when receiving access from recruiter apparatus 200. Similarly, sharing server 100 requests sign-in accompanied by input of a member ID and a password when receiving access from applicant apparatus 300. Sharing server 100 identifies each of the recruiter and the applicant by the member ID notified at the time of sign-in.

Recruiter apparatus 200 receives various operations of the recruiter. For example, recruiter apparatus 200 receives an operation of inputting a recruitment case (requested business), an operation of inputting an evaluation of a vendor who has finished the business, an operation of searching for a member of the matching service, and the like.

Recruiter apparatus 200 communicates with sharing server 100 in response to each operation on recruiter apparatus 200. Sharing server 100 registers a recruitment case in database 120 in response to an operation of inputting the recruitment case (requested business), registers an evaluation of a target applicant (vendor) in database 120 in response to an operation of inputting the evaluation, and provides information on a member to recruiter apparatus 200 in response to an operation of searching for the member.

Applicant apparatus 300 receives various operations of the applicant. For example, applicant apparatus 300 receives an operation of searching for a recruitment case, an operation of applying for a recruitment case, an operation of inputting a business achievement, and the like.

Applicant apparatus 300 communicates with sharing server 100 in response to each operation on applicant apparatus 300. Sharing server 100 provides an appropriate recruitment case to applicant apparatus 300 in response to an operation of searching for the recruitment case, issues a notification of acceptance or rejection to applicant apparatus 300 in response to an operation of applying for the recruitment case, and registers a business achievement in database 120 in response to an operation of inputting the business achievement.

As described above, matching system 1 includes an evaluation system for evaluating applicants (vendors) of a business and a recruitment system for recruiting vendors of a business.

A recruiter belonging to a certain department of enterprise A can adopt an applicant belonging to another department of enterprise A as a vendor for a recruitment case by utilizing matching system 1. The recruiter belonging to enterprise A can adopt the applicant belonging to enterprise B as the vendor for the recruitment case by utilizing matching system 1.

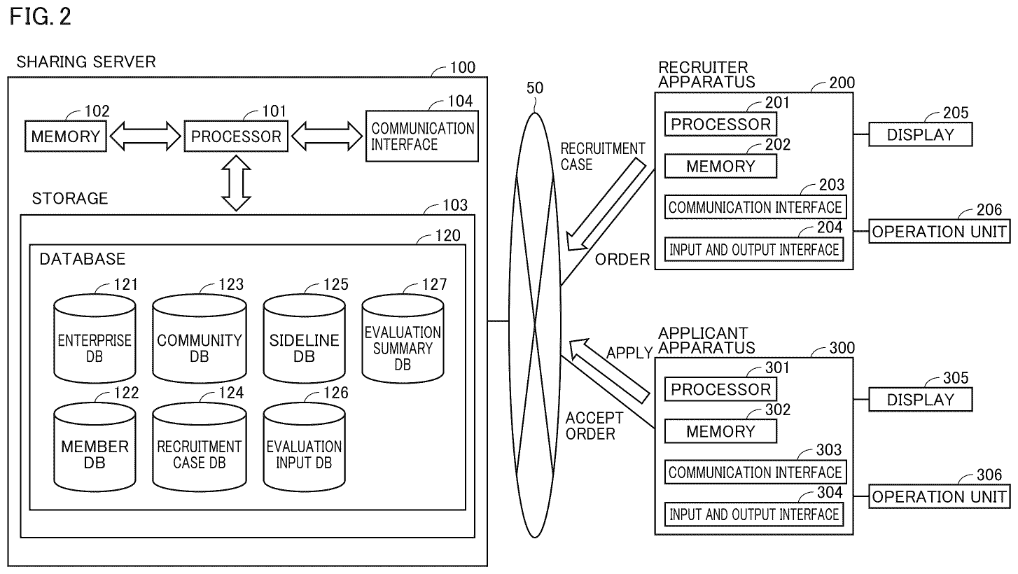

FIG. 2 is a block diagram illustrating the configuration of sharing server 100, recruiter apparatus 200, and applicant apparatus 300.

### Configuration of Sharing Server

Sharing server 100 includes a processor 101, a memory 102, a storage 103, and a communication interface 104.

Memory 102 includes a random access memory (RAM), a read only memory (ROM), a flash memory, or any other suitable memory system. Memory 102 can store a program for arithmetic processing of processor 101, temporary data calculated in the arithmetic processing, and the like.

Storage 103 can include a hard disk drive, a solid state drive, and the like. Storage 103 can store database 120. Database 120 can include a plurality of types of databases. The plurality of types of databases can include an enterprise database (enterprise DB) 121, a member database (member DB) 122, a community database (community DB) 123, a recruitment case database (recruitment case DB) 124, a sideline database (sideline DB) 125, an evaluation input database (evaluation input DB) 126, and an evaluation summary database (evaluation summary DB) 127.

A part of the plurality of types of databases may be stored in a storage provided separately from sharing server 100. For example, the databases may be connected to a cloud service which is separate from sharing server 100, and a part of the plurality of types of databases illustrated in FIG. 2 may be stored on the cloud. In this case, sharing server 100 can access a database by communicating with the cloud via internet 50.

Processor 101 can be connected to internet 50 via communication interface 104 in accordance with the program stored in memory 102. Processor 101 can be connected to internet 50 and communicates with recruiter apparatus 200 and applicant apparatus 300. Processor 101 accesses database 120 and executes a process of extracting data, a process of registering new data in database 120, a process of updating data registered in database 120, and the like.

### Configuration of Recruiter Apparatus

Recruiter apparatus 200 can include a processor 201, a memory 202, a communication interface 203, an input and output interface 204, a display 205, and an operation unit 206. Operation unit 206 can include a mouse, a keyboard, and the like.

Memory 202 can include a random access memory (RAM), a read only memory (ROM), a flash memory, or any other suitable memory system. Memory 202 can store a program for arithmetic processing of processor 201, temporary data calculated in the arithmetic processing, and the like.

Processor 201 is connected to internet 50 via communication interface 203 in accordance with the program stored in memory 202. Processor 201 is connected to internet 50 and communicates with sharing server 100. Processor 201 communicates with sharing server 100 and executes a process of transmitting a recruitment case, a process of displaying information on members who are applicants on display 205, a process of ordering a business from a vendor selected from the applicants, a process of transmitting the content of evaluation of the vendor input by the recruiter to sharing server 100, and the like.

Information input by an operation of operation unit 206 is notified to processor 201 via input and output interface 204.

### Configuration of Applicant Apparatus

Applicant apparatus 300 can include a processor 301, a memory 302, a communication interface 303, an input and output interface 304, a display 305, and an operation unit 306. Operation unit 306 can include a mouse, a keyboard, and the like.

Memory 302 can include a random access memory (RAM), a read only memory (ROM), a flash memory, or any other suitable memory system. Memory 302 can store a program for arithmetic processing of processor 301, temporary data calculated in the arithmetic processing, and the like.

Processor 301 is connected to internet 50 via communication interface 303 in accordance with the program stored in memory 302. Processor 301 is connected to internet 50 and communicates with sharing server 100. Processor 301 communicates with sharing server 100 and executes a process of applying for a recruitment case, a process of displaying a notification of acceptance or rejection of the applied case on display 305, a process of transmitting the achievement of the accepted business to sharing server 100, and the like.

Information input by an operation of operation unit 306 is notified to processor 301 via input and output interface 304.

### Overview of Database

Hereinafter, an overview of database 120 will be described. Information on enterprises that participate in matching system 1 is registered in enterprise database 121. Information on members who utilize matching system 1 is registered in member database 122. Many members are employees of enterprises that participate in matching system 1.

The members registered in member database 122 can act as recruiters (purchasers) or applicants (vendors) by utilizing matching system 1. The members may include employees belonging to the enterprises registered in enterprise database 121 and individuals (freelances) not belonging to the enterprises.

Community database 123 can store information for identifying enterprises belonging to a community. The community is formed by an agreement among enterprises. Therefore, a plurality of communities can be formed depending on the way of agreement among enterprises. The number of enterprises belonging to one community can be set in various ways. Enterprises having a community relation form a trust relation within a range determined by the way of agreement when forming the community. Information for identifying enterprises belonging to a community is registered for each community in community database 123.

A business (recruitment case) for which a vendor is recruited is registered in recruitment case database 124. An employee of each enterprise can accept an order for a case of another department of the enterprise or a case of another enterprise registered in recruitment case database 124 as a member of matching system 1 while engaging in the main business of the department to which the employee belongs in the enterprise. In this case, the member accepts the order for the case of another department of the enterprise or the case of another enterprise as a sideline.

Data indicating the status of the sideline is registered in sideline database 125 for each member. The data indicating the status of the sideline includes information such as sideline achievement and sideline schedule.

Information on evaluation of applicants (vendors) of a business is registered in evaluation input database 126. A recruiter (purchaser) of a business can evaluate the job of an applicant (vendor) who has finished the business as an evaluator by utilizing matching system 1. The evaluation made by each evaluator is registered in evaluation input database 126.

Evaluation summaries are registered in evaluation summary database 127. Evaluation summaries are registered in evaluation summary database 127 for each member. The recruiter can browse the evaluation summaries. The recruiter can select a member who is considered to be appropriate as a vendor while browsing the evaluation summary of the member who applies for the recruitment case.

### Enterprise Database

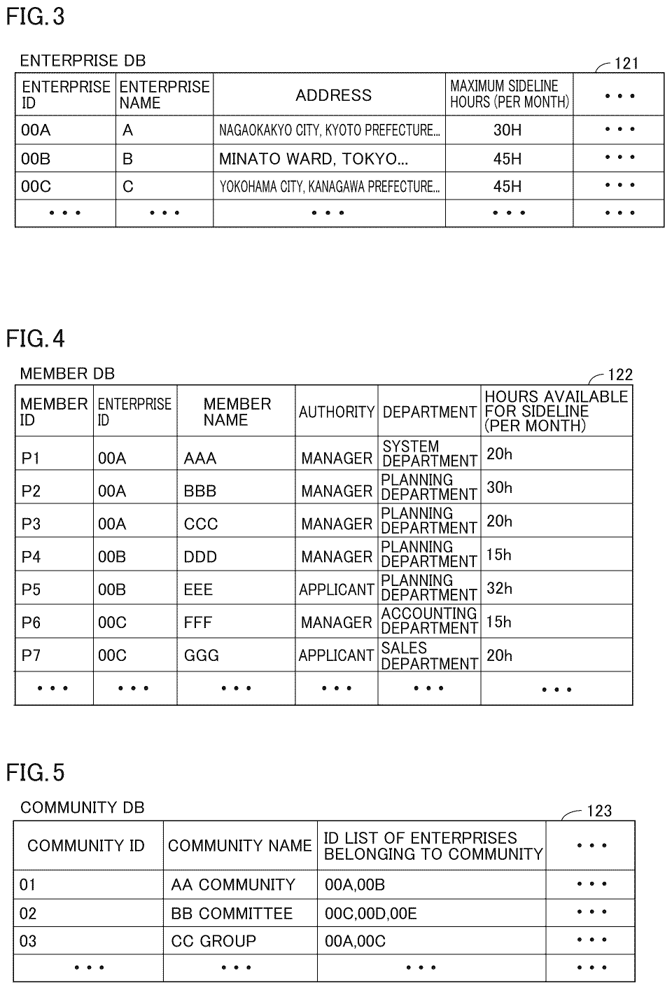

FIG. 3 is a diagram illustrating an example of enterprise database 121. An enterprise ID for identifying an enterprise, an enterprise name, an enterprise address, and maximum sideline hours are registered for each enterprise in enterprise database 121. The maximum sideline hours are the maximum hours during which the employee is allowed to perform business as a sideline separately from the main business. The maximum sideline hours are determined for each enterprise. For example, the maximum sideline hours can be calculated based on “specified overtime hours-overtime hours in the main work other than the sideline”. The “specified overtime hours” vary depending on the enterprise. Although the maximum sideline hours are illustrated on a monthly basis in FIG. 3, the maximum hours may be illustrated on a weekly basis. The unit of the maximum sideline hours may be determined for each enterprise.

According to the present embodiment, a member is allowed to apply for a business that is recruited by various enterprises and departments and accept an order for the business within a range that does not exceed the maximum sideline hours that are set by the enterprise to which the member belongs.

### Member Database

FIG. 4 is a diagram illustrating an example of member database 122. Various kinds of information on a member can be registered in member database 122. The various kinds of information on the member include a member ID for identifying the member, an ID of an enterprise to which the member belongs, a member name, a member authority, a department to which the member belongs, and hours available for sideline.

The types of the member authority include manager and applicant. The member having the manager authority is given authority to use matching system 1 as a recruiter and an applicant. The member having the applicant authority is given authority to use matching system 1 as an applicant, but is not given authority to use matching system 1 as a recruiter. A department head in the enterprise is given the manager authority to manage the sideline status of the subordinates in the department. The manager having the manager authority is given authority to approve an application of an applicant who is a subordinate. Thus, the manager acts as an approver.

The hours available for sideline are the remaining hours during which the member can engage in a sideline. The hours available for sideline are calculated based on “maximum sideline hours-total sideline hours”. When a target is engaged in a plurality of sidelines, the total sideline hours include the hours already spent on the plurality of sidelines. The total sideline hours include the expected hours of the sideline in addition to the hours already spent on the sideline. The expected hours of the sideline are calculated based on the assumed man-hours registered in recruitment case database 124. FIG. 4 illustrates the hours available for sideline on a monthly basis. Only the businesses which can be handled with the man-hours within the range of the hours available for sideline are provided as the cases which can be applied for to the applicant who searches for the recruitment business by utilizing matching system 1.

### Community Database

FIG. 5 is a diagram illustrating an example of community database 123. Information on a community formed among enterprises is registered in community database 123. The information on the community includes a community ID for identifying the community, a community name, and an ID list of enterprises belonging to the community. Each enterprise can form various communities by making agreements with other enterprises. The enterprise belonging to the community can change the target enterprise belonging to the community by making an agreement with another enterprise.

### Recruitment Case Database

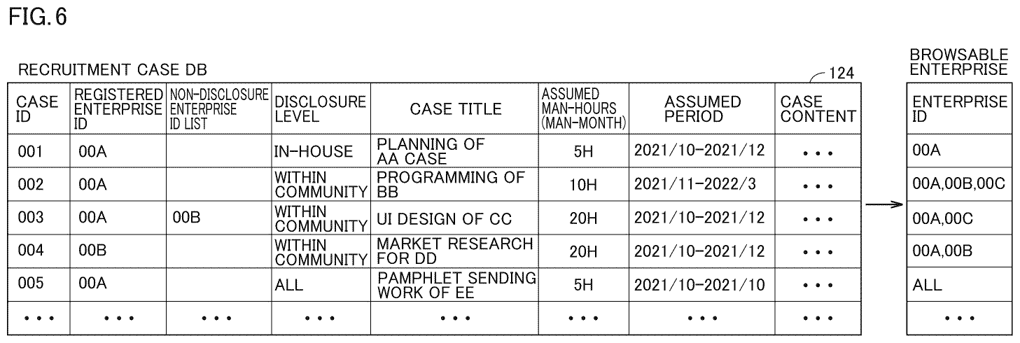

FIG. 6 is a diagram illustrating an example of recruitment case database 124. Information on the recruitment cases is registered in recruitment case database 124. The information on a recruitment case includes a case ID for identifying the recruitment case, an ID of an enterprise to which the recruiter who has registered the recruitment case belongs, a non-disclosure enterprise ID list, a disclosure level, a case title, assumed man-hours, an assumed period, and a case content.

The IDs of enterprises that are prohibited from disclosing the recruitment cases are registered in the non-disclosure enterprise ID list. As the disclosure level, one of three levels of “in-house”, “within community”, and “all” is set. When the disclosure level is set to “all”, the disclosure targets also include applicants outside the community.

The IDs of enterprises whose recruitment cases can be browsed are illustrated on the right side of recruitment case database 124 in FIG. 6. For example, in the recruitment case corresponding to the case ID=001, the disclosure level is set to “in-house”. In this case, only members belonging to the enterprise (enterprise ID=00A) that has registered the recruitment case can browse the recruitment case corresponding to the case ID=001.

Hereinafter, the recruitment cases corresponding to each case ID may be referred to as case 001, case 002, case 003 . . . using the case IDs. Similarly, the communities corresponding to each community ID may be referred to as community 01, community 02, community 03 . . . using the community IDs, and the members corresponding to each member ID may be referred to as member P1, member P2, member P3 . . . using the member IDs. In addition, hereinafter, enterprises corresponding to each enterprise ID may be referred to as enterprise A, enterprise B, enterprise C . . . using a part of the enterprise IDs.

In case 002, the disclosure level is set to “within community”. According to community database 123 illustrated in FIG. 5, enterprises having a community relation with enterprise A that has registered case 002 are enterprise B and enterprise C. Therefore, as illustrated in FIG. 6, only the members belonging to any of enterprise A, enterprise B, enterprise C can browse case 002.

Case 003 is the same as case 002 in the registered enterprise and the disclosure level of the recruitment case. Here, in case 003, “00B” is registered in the non-disclosure enterprise ID list. Therefore, as illustrated in FIG. 6, only the members belonging to either enterprise A or enterprise C can browse case 003, and the members belonging to enterprise B are not authorized to browse case 003.

In the case of the recruitment case whose disclosure level is set to “all”, all the members can browse the target recruitment case. Case 005 illustrated in FIG. 6 corresponds to this. If the IDs of one or a plurality of enterprises are registered in the non-disclosure enterprise ID list of case 005, the members belonging to the enterprises having those enterprise IDs are not given the authority to browse case 005.

The assumed man-hours and the assumed period are used by the applicant and matching system 1 to assume the hours for processing the recruitment case.

### Sideline Database

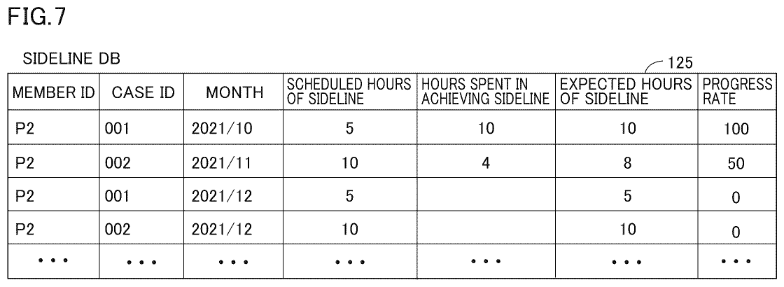

FIG. 7 is a diagram illustrating an example of sideline database 125. Information indicating a status of a sideline of a member is registered for each sideline case in sideline database 125. The information indicating the status of the sideline includes an ID of the member engaged in the sideline, a case ID, a month (the period of engagement in the sideline), scheduled hours of the sideline, hours spent in achieving the sideline, expected hours of the sideline, and a progress rate.

The scheduled hours of the sideline are hours considered for the member to process the accepted case. A member who accepts an order for a sideline inputs scheduled hours of the sideline from the member's applicant apparatus 300 every month. The input scheduled hours of the sideline are reflected in sideline database 125. For example, the assumed man-hours of case 001 are set to 5 hours/man-month in recruitment case database 124. This implies a workload of 5 hours per person per month. Usually, the member inputs the scheduled hours of the sideline with the estimated man-hours of the recruitment case as a guide.

The hours spent in achieving the sideline are the hours during which the member has actually engaged in the accepted case. In other words, the hours spent in achieving the sideline are the hours during which the member has already worked as an achievement. The member inputs the hours spent on the business of the case at an arbitrary timing using the member's applicant apparatus 300 every time the member is engaged in the case until the business of the accepted case is completed. The accumulated hours input using applicant apparatus 300 are registered as the hours spent in achieving the sideline every month in sideline database 125.

The expected hours of the sideline are hours assumed for the business of the target case. In other words, the expected hours of the sideline are hours expected as the member's future working hours. Sharing server 100 automatically sets the expected hours of the sideline in consideration of the scheduled hours of the sideline and the hours spent in achieving the sideline. The member may be allowed to input the expected hours of the sideline at an arbitrary timing using the member's applicant apparatus 300 until the business of the target case is completed. Further, the member may be allowed to modify the automatically set expected hours of the sideline. It is desirable that the expected hours of the sideline are less than or equal to the scheduled hours of the sideline. However, depending on the status of the case, the expected hours of the sideline may be longer than the scheduled hours of the sideline. The member engaged in the case may be allowed to update the expected hours of the sideline at any timing until the business of the case is completed.

The progress rate indicates the degree of progress of the sideline. The progress rate is input based on the determination of the person engaged in the sideline. The progress rate is input between 0(%) and 100(%), for example.

For example, when a member initially accepts an order for a certain case, the progress rate is 0%, the hours spent in achieving the sideline is 0 hour, and the scheduled hours of the sideline and the expected hours of the sideline coincide with each other. The expected hours of the sideline changes in conjunction with the member's progress of the business of the case and the input of the hours spent in achieving the sideline and the progress rate.

Sideline database 125 illustrated in FIG. 7 shows the sideline data from October 2021 to December 2021 of member P2. Referring to sideline database 125 illustrated in FIG. 7, it is understood that member P2 is engaged in case 001 and case 002 during the period from October 2021 to December 2021.

As the data of October of case 001, the scheduled hours of the sideline=5, the hours spent in achieving the sideline=10, and the expected hours of the sideline=10 are registered in sideline database 125. Thus, it is understood that member P2 has engaged in case 001 in October in excess of the scheduled hours of the sideline.

As the data of November of case 002, the scheduled hours of the sideline=10, the hours spent in achieving the sideline=4, and the expected hours of the sideline=8 are registered in sideline database 125. Thus, it is understood that member P2 has engaged in case 002 in November without exceeding the set expected hours of the sideline. Since the progress rate is 50%, it is understood that member P2 has finished half of the entire business of case 002 in November.

As the data of December of case 001, in sideline database 125, the scheduled hours of the sideline=5 and the expected hours of the sideline=5 are registered, and the hours spent in achieving the sideline are not registered. Similarly, the hours spent in achieving the sideline are not registered as the data of December of case 002. These imply that the input of the hours spent in achieving the sideline by member P2 is awaited.

Sharing server 100 calculates the available capacity of the member to additionally perform the sideline by using the expected hours of the sideline and the hours spent in achieving the sideline of sideline database 125. When the member is engaged in a plurality of sidelines, sharing server 100 calculates a “total expected hours of the sidelines” which is a total of expected hours of the sidelines corresponding to the plurality of sidelines and a “total hours spent in achieving the sidelines” which is a total of hours spent in achieving the sidelines corresponding to the plurality of sidelines. Sharing server 100 calculates the available capacity for sideline by calculating “maximum sideline hours-(total expected hours of the sidelines+total hours spent in achieving the sidelines)”. Here, when “total expected hours of the sidelines+total hours spent in achieving the sidelines” is defined as “total sideline hours”, the available capacity for sideline, that is, “hours available for sideline” is calculated based on “maximum sideline hours-total sideline hours”. For example, in sideline database 125 illustrated in FIG. 7, the total expected hours of the sidelines, which is the total of the expected hours of the sidelines of December of member P2, are 15 hours (5 hours+10 hours). The total hours spent in achieving the sidelines of December of member P2 are zero. At this time, if the “maximum sideline hours” defined by the enterprise to which member P2 belongs is 30 hours, the available capacity of member P2 for sideline (hours available for sideline) is calculated to be 15 hours (30 hours-15 hours).

Here, an example of a more specific calculation procedure of the expected hours of the sideline will be described. For example, the “expected hours of the sideline” may be calculated based on a calculation formula of “(man-hour progress rate/progress rate)×scheduled hours of the sideline-hours spent in achieving the sideline”. Here, the “man-hour progress rate” is calculated based on “hours spent in achieving the sideline/scheduled hours of the sideline”. As described above, the “progress rate” is a rate input to sideline database 125 based on the determination of the person engaged in the sideline.

For example, when the scheduled hours of the sideline is 10 hours and the hours spent in achieving the sideline is 2 hours, the man-hour progress rate is calculated to be 20%. Here, the progress rate is set to 40%. In this case, the expected hours of the sideline are calculated to be “(20%/40%)×10 hours-2 hours”=3 hours. That is, according to this calculation result, the expected hours of the sideline for the target sideline are 3 hours.

### Evaluation Input Database

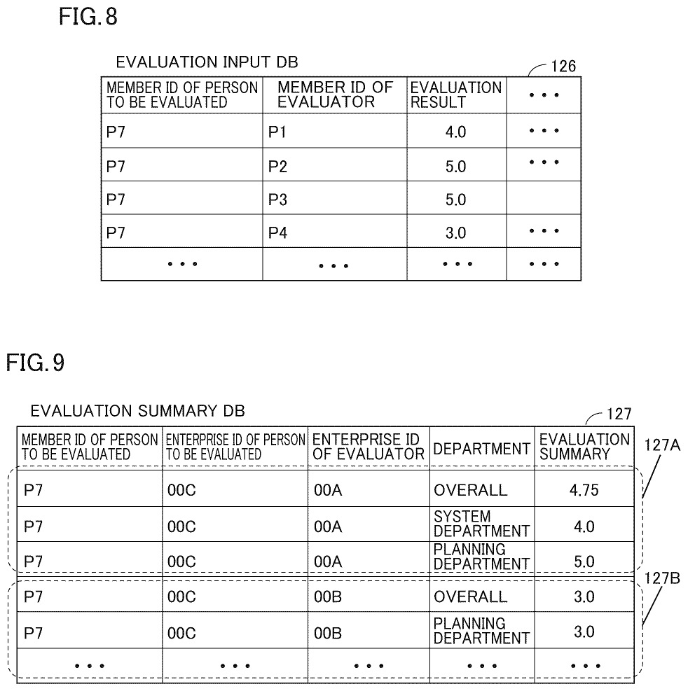

FIG. 8 is a diagram illustrating an example of evaluation input database 126. Information on evaluation of a person to be evaluated is registered in evaluation input database 126. The information on the evaluation includes a member ID of the person to be evaluated, a member ID of the evaluator, and an evaluation result.

The person to be evaluated is a vendor for the case among applicants to the recruitment case. The evaluator is a recruiter (purchaser) of the case. The evaluation of the person to be evaluated is registered for each evaluator in evaluation input database 126. The evaluation result is represented by a numerical value having 10 as a maximum value and 0 as a minimum value. FIG. 8 shows an example in which member P7 corresponds to the person to be evaluated.

When the business requested to the applicant (vendor) is completed, the recruiter (purchaser) of the business evaluates the person to be evaluated who is the applicant as the evaluator using recruiter apparatus 200. The evaluation result of the evaluator is registered in evaluation input database 126. When a certain recruiter once again requests another business to an applicant to whom a business has been requested, the recruiter evaluates the applicant once again. In this case, the average value of the previous evaluation result and the subsequent evaluation result is registered in evaluation input database 126.

Therefore, the average value of the evaluations of evaluators for the person to be evaluated is reflected in the evaluation result registered in evaluation input database 126. Instead of the average value, a weighted average value, a deviation value, or the like calculated according to the number of evaluations may be adopted. Evaluation results for each case ID may be further registered in evaluation input database 126.

### Evaluation Summary Database

FIG. 9 is a diagram illustrating an example of evaluation summary database 127. Information on evaluation by department of a person to be evaluated is registered in evaluation summary database 127. Information on evaluation by organization can include a member ID of the person to be evaluated, an ID of the enterprise to which the person to be evaluated belongs, an ID of the enterprise to which the evaluator belongs, a department to which the evaluator belongs, and an evaluation summary.

FIG. 9 illustrates an example in which member P7 corresponds to the person to be evaluated. The enterprise ID of the person to be evaluated is “00C”. Therefore, member P7 belongs to enterprise C. In FIG. 9, a data group 127A represents the evaluation of enterprise A for member P7, and a data group 127B represents the evaluation of enterprise B for member P7.

Referring to data group 127A, it is understood that the evaluation of enterprise A is classified into the categories of the evaluation of the entire enterprise, the evaluation of the system department in enterprise A, and the evaluation of the planning department in enterprise A. In the evaluation summary, average values of the classified evaluations corresponding to each of the categories are registered.

For example, as the evaluation summary corresponding to entire enterprise A, an average value of the evaluation results of the members of enterprise A who have evaluated member P7 is registered. As the evaluation summary corresponding to the system department, the average value of the evaluation results of the members belonging to the system department among the members of enterprise A who have evaluated member P7 is registered.

Similarly, the evaluation summary of entire enterprise B and the evaluation summary by department of enterprise B are registered in evaluation summary database 127 for data group 127B representing the evaluation of enterprise B for member P7.

Sharing server 100 identifies the evaluation result of each member using evaluation input database 126 and identifies the affiliation of each member using member database 122. Sharing server 100 updates data of evaluation summary database 127 based on these identification results.

Note that, although only member P7 is shown as the person to be evaluated in FIG. 9, other members P1 to P6, member P8, member P9 . . . are also registered in evaluation summary database 127 as the persons to be evaluated.

### Functions of Sharing Server, Recruiter Apparatus, and Applicant Apparatus

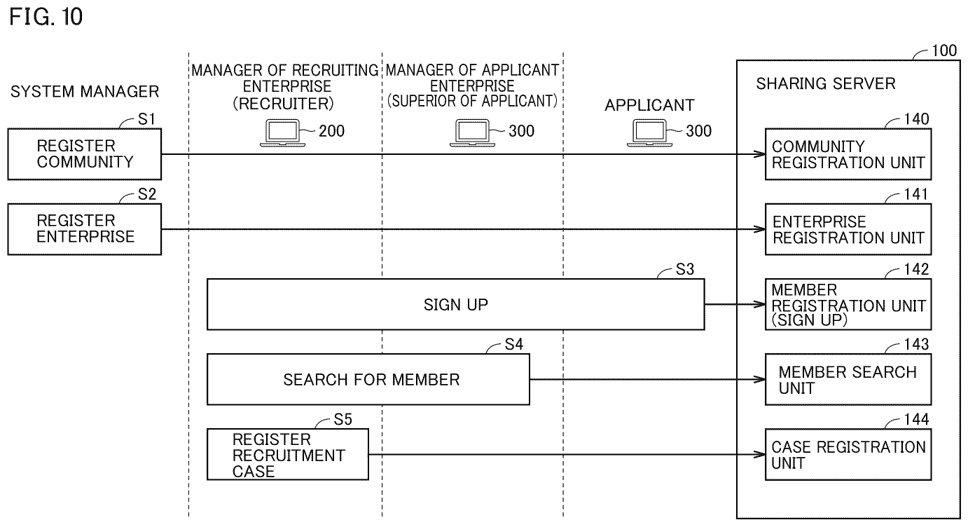

FIGS. 10 to 12 are diagrams illustrating functions of the sharing server, the recruiter apparatus, and the applicant apparatus.

As illustrated in FIG. 10, sharing server 100 functionally includes a community registration unit 140, an enterprise registration unit 141, a member registration unit 142, a member search unit 143, and a case registration unit 144. These various functions are implemented by processor 101, memory 102, storage 103, and communication interface 104 included in sharing server 100.

Community registration unit 140 has a function of registering a community in community database 123. A system manager who manages matching system 1 inputs information on a community to sharing server 100 using an operation unit such as a keyboard which is not illustrated.

The information on the community includes a community name and information on the enterprises belonging to the community. Community registration unit 140 registers the community in community database 123 in accordance with the input of the system manager (step S1). Community registration unit 140 further has a function of updating the information on the community registered in community database 123.

Enterprise registration unit 141 has a function of registering a new enterprise that participates in matching system 1. The system manager inputs information on the enterprise to sharing server 100 using an operation unit such as a keyboard.

The information on the enterprise includes information such as an enterprise name, an address, and maximum sideline hours. Enterprise registration unit 141 registers the enterprise in enterprise database 121 in accordance with the input of the system manager (step S2). Enterprise registration unit 141 further has a function of updating information on an enterprise that has already been registered.

Member registration unit 142 has a function of registering (signing up) a new member who joins matching system 1. Member registration unit 142 issues a member ID and a password in response to a request from a person who belongs to an enterprise that has participated in matching system 1. A person who desires to become a member executes a sign-up process using a personal computer or the like (step S3).

Specifically, a person who desires to become a member inputs information such as a name, an enterprise to which the person belongs, and a department to which the person belongs to a personal computer or the like, and transmits the input information to sharing server 100. Member registration unit 142 registers the input information in member database 122. The new member can sign in to sharing server 100 using the personal computer used for the member registration. In this case, the personal computer functions as recruiter apparatus 200 or applicant apparatus 300.

In FIG. 10, two applicant apparatuses 300 are illustrated. One of the apparatuses is assumed to be operated by a manager of an applicant enterprise. The other apparatus is assumed to be operated by a person other than manager of the applicant enterprise. The manager of the applicant enterprise is engaged in a managerial position such as department head, and corresponds to the superior of an applicant who is a subordinate. In the present embodiment, the manager of the applicant enterprise serves as an approver who approves the application to the recruitment case by the subordinate.

Member search unit 143 has a function of searching for a member of matching system 1. Recruiter apparatus 200 executes a member search process after receiving a search operation by a recruiter (step S4). Similarly, when applicant apparatus 200 receives a search operation of a manager corresponding to a superior of a certain applicant, applicant apparatus 200 executes a member search process (step S4). Member search unit 143 provides information on members registered in member database 122 to recruiter apparatus 200 and applicant apparatus 300 of the manager.

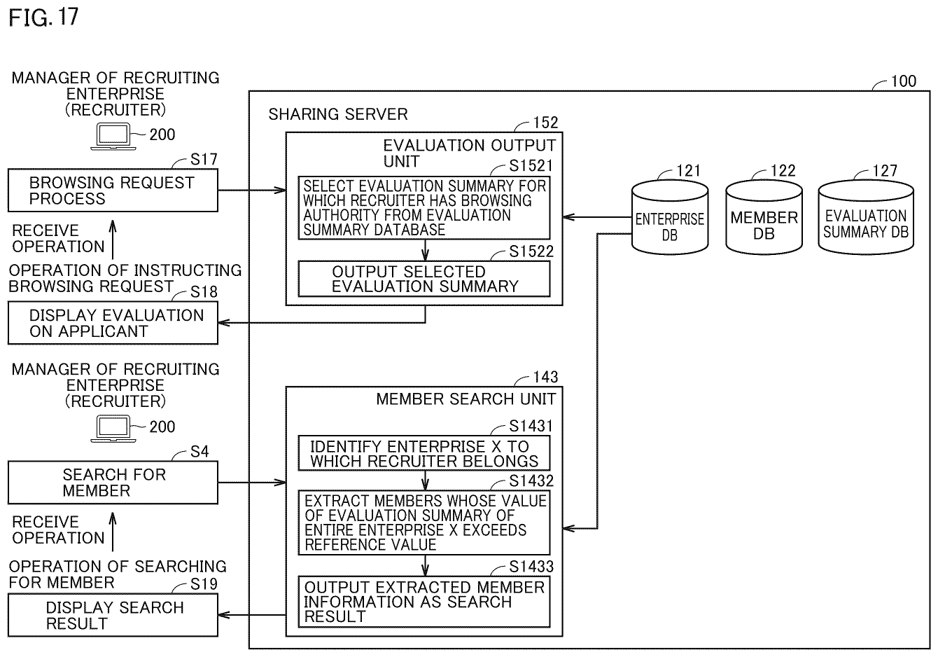

The member search process (step S4) executed by recruiter apparatus 300 and the process of member search unit 143 will be described in detail later with reference to FIG. 17.

Case registration unit 144 has a function of registering a recruitment case in recruitment case database 124. When recruiter apparatus 200 receives an operation of inputting a recruitment case, recruiter apparatus 200 executes a process of registering the recruitment case (step S5). In the process of registering the recruitment case, recruiter apparatus 200 transmits information on the recruitment case to sharing server 100. Case registration unit 144 registers the received information on the recruitment case in recruitment case database 124.

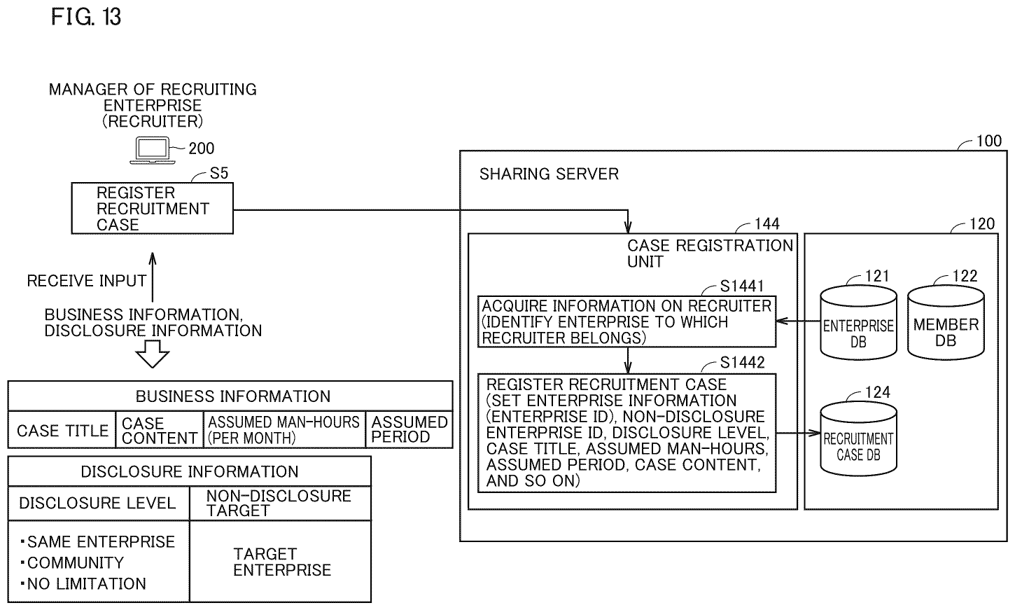

The recruitment case registration process (step S5) executed by recruiter apparatus 200 and the process of case registration unit 144 will be described in detail later with reference to FIG. 13.

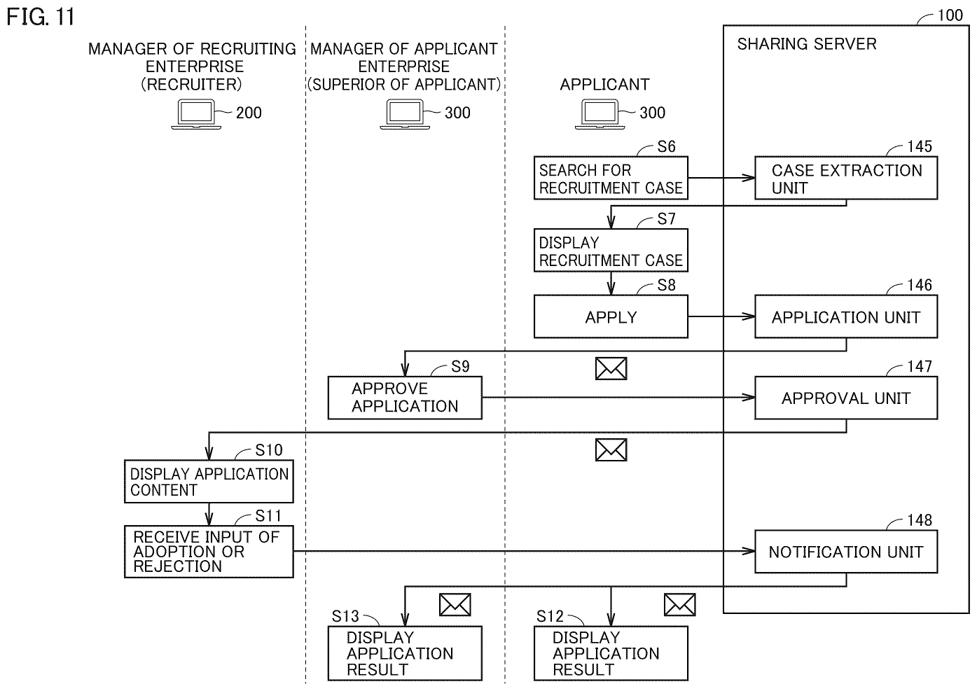

As illustrated in FIG. 11, sharing server 100 functionally includes a case extraction unit 145, an application unit 146, an approval unit 147, and a notification unit 148. These various functions are implemented by processor 101, memory 102, storage 103, and communication interface 104 included in sharing server 100.

Case extraction unit 145 has a function of extracting a recruitment case that can be browsed by an applicant. Application unit 146 has a function of submitting an application by an applicant to a manager (a superior of the applicant). Approval unit 147 has a function of transmitting the contents of the application for the recruitment case to the recruiter on condition that the approval of the application has been received from the manager (approver). Notification unit 148 has a function of receiving a result of whether or not to adopt an applicant from a recruiter and notifying the applicant and the manager of the result.

Application unit 146, approval unit 147, and notification unit 148 implement notification of requesting approval to the manager, notification of the applicant to the recruiter, and notification of the application result to the applicant by a workflow system.

When applicant apparatus 300 receives an operation of the applicant requesting a search for a recruitment case, applicant apparatus 300 executes a search process for the recruitment case (step S6). In the search process for the recruitment case, applicant apparatus 300 transmits a search request to case extraction unit 145 of sharing server 100.

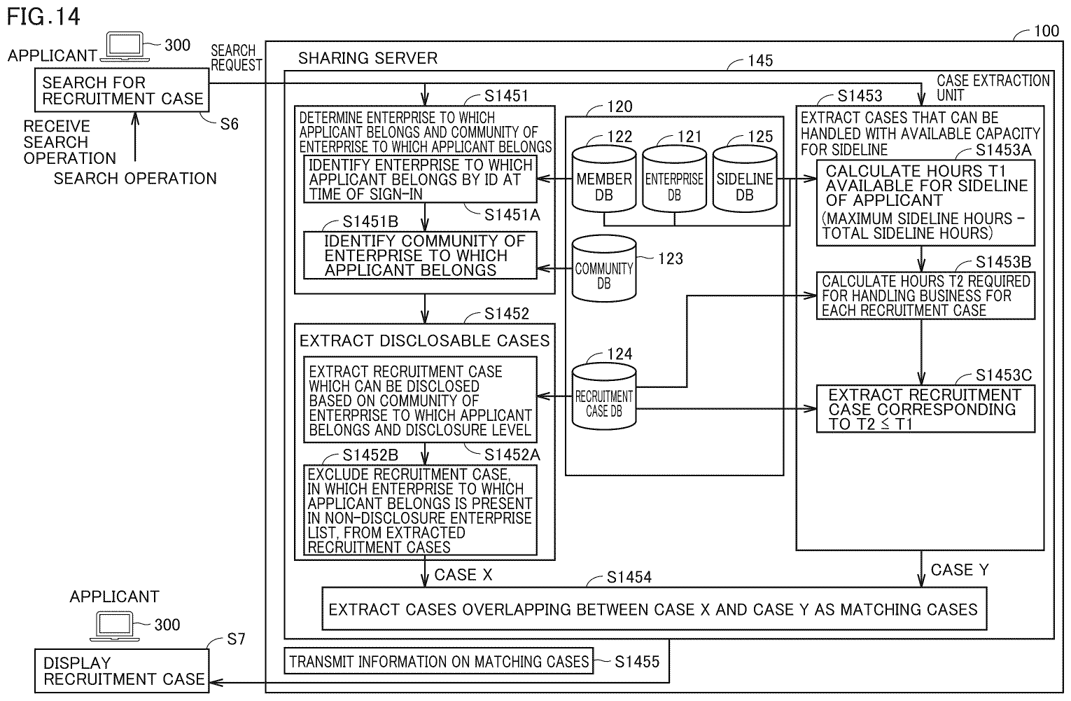

When case extraction unit 145 receives the search request, case extraction unit 145 extracts cases allowed to be browsed by the applicant from the recruitment cases registered in recruitment case database 124, and transmits the extracted cases to applicant apparatus 300. Case extraction unit 145 determines whether a case is allowed to be browsed by the applicant based on a first criterion and a second criterion. The first criterion is a disclosure range set for the recruitment case. The second criterion is the available capacity for sideline of the applicant. The disclosure range is determined by a disclosure information illustrated in FIG. 13. The available capacity for sideline is calculated as hours available for sideline illustrated in FIG. 14.

Case extraction unit 145 determines cases satisfying both the first criterion and the second criterion as the cases allowed to be browsed by the applicant. Therefore, case extraction unit 145 extracts the cases allowed to be disclosed to the applicant who has received the search request from the recruitment cases registered in recruitment case database 124. Further, case extraction unit 145 extracts the cases that can be handled within the hours available for sideline of the applicant who has received the search request from the recruitment cases registered in recruitment case database 124. Case extraction unit 145 transmits the cases that are allowed to be browsed by the applicant to applicant apparatus 300.

Case extraction unit 145 may receive an operation of setting a criterion for extracting a case. For example, a function that allows the system manager to select any of a first setting that enables only the first criterion, a second setting that enables only the second criterion, and a third setting that enables both the first criterion and the second criterion may be added to sharing server 100.

Applicant apparatus 300 receives the recruitment cases from case extraction unit 145. Applicant apparatus 300 displays the received recruitment cases on display 305 (step S7).

The recruitment case search process (step S6), the process of displaying the recruitment case (step S7), and the process of case extraction unit 145 will be described in detail later with reference to FIG. 14.

The applicant performs an operation of selecting an application target from the recruitment cases displayed on display 305 on applicant apparatus 300. Applicant apparatus 300 executes the application process in response to the operation of the applicant (step S8). In the application process, applicant apparatus 300 transmits application information indicating the application target case to application unit 146 of sharing server 100. Thus, the order reception desire for the business is transmitted from applicant apparatus 300 to application unit 146.

Application unit 146 transmits the application information received from applicant apparatus 300 to applicant apparatus 300 of the manager (the superior of the applicant). Application unit 146 identifies the member ID of the superior who is the manager of the applicant, for example, based on the relation between the member ID of the applicant and the member ID of the superior registered in member database 122. Application unit 146 transmits application information on the subordinate to applicant apparatus 300 corresponding to the identified member ID of the superior. The manager checks the business applied by the subordinate on the manager's applicant apparatus 300. The manager performs an operation to approve the application on applicant apparatus 300. Applicant apparatus 300 receives the approval operation and executes an application approval process (step S9). In the application approval process, applicant apparatus 300 transmits approval information to approval unit 147 of sharing server 100. Thus, approval information, which is an example of approval notification, is transmitted from applicant apparatus 300 of the manager (approver) to approval unit 147.

Approval unit 147 accepts the application of the applicant on condition that the approval information is received from applicant apparatus 300. Thus, in the present embodiment, the application of the applicant is accepted on condition that the manager to which the applicant belongs approves the application. Therefore, the manager can check in advance the contents of the recruitment business that the subordinate is going to apply for. As a result, it is possible to prevent confidential information from leaking to the outside of the enterprise through the employee's sideline action.

Note that FIG. 11 illustrates a flow when the manager approves the application. If an operation to reject the application is received in step S9, rejection information is transmitted from applicant apparatus 300 of the manager to approval unit 147. When the rejection information is received, approval unit 147 may notify applicant apparatus 300 of the applicant of the rejection of the application.

Approval unit 147 which has accepted the application of the applicant transmits application information to recruiter apparatus 200. The application information includes information on the applicant and the contents of the application target business. Recruiter apparatus 200 displays the application contents on display 205 (step S10). The recruiter checks the applicant and the applied business based on the display of display 205, and determines whether or not to adopt the applicant.

The recruiter inputs the result of the determination of adoption or rejection to recruiter apparatus 200. Recruiter apparatus 200 receives the input result (step S11). Recruiter apparatus 200 transmits the received result of adoption or rejection to notification unit 148 of sharing server 100.

After receiving the result of adoption or rejection from recruiter apparatus 200, notification unit 148 transmits the application result (the result of adoption or rejection) to applicant apparatus 300 of the applicant and applicant apparatus 300 of the manager.

Applicant apparatus 300 of the applicant and applicant apparatus 300 of the manager display the application result on display 305 (step S12, step S13). The applicant and the manager check the application result by viewing the display of display 305.

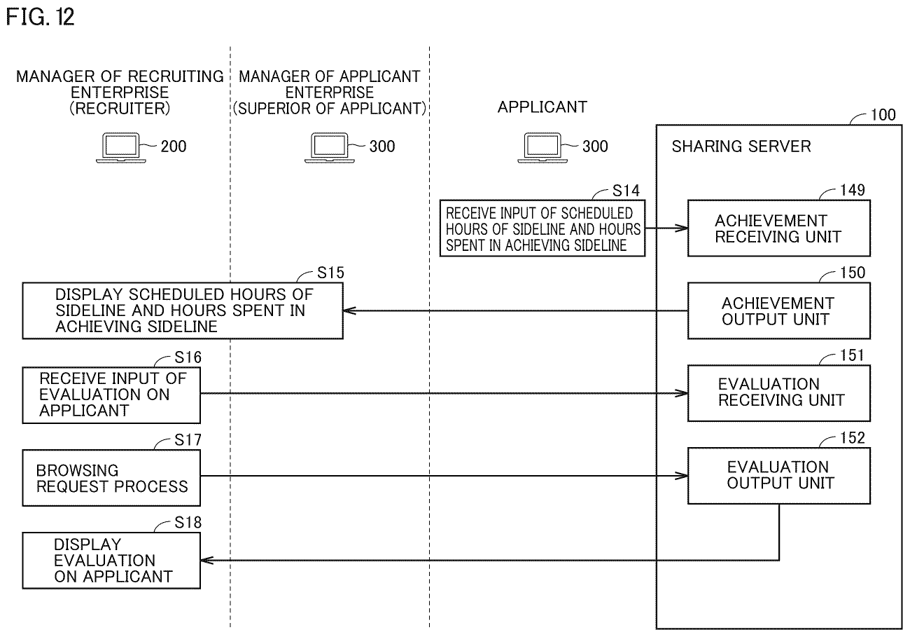

As illustrated in FIG. 12, sharing server 100 functionally includes an achievement receiving unit 149, an achievement output unit 150, an evaluation receiving unit 151, and an evaluation output unit 152. These various functions are implemented by processor 101, memory 102, storage 103, and communication interface 104 included in sharing server 100.

Achievement receiving unit 149 has a function of receiving the scheduled hours of the sideline and the hours spent in achieving the sideline input by the applicant on applicant apparatus 300. Achievement output unit 150 has a function of outputting information including the scheduled hours of the sideline and the hours spent in achieving the sideline of the applicant to recruiter apparatus 200 or applicant apparatus 300 of the manager.

Evaluation receiving unit 151 has a function of receiving the evaluation of the applicant (vendor) input by the recruiter on recruiter apparatus 200. Evaluation output unit 152 has a function of outputting information indicating the evaluation of the applicant to recruiter apparatus 200.

When the applicant engages in a sideline, the applicant inputs the scheduled hours of the sideline and the hours spent in achieving the sideline to applicant apparatus 300. The applicant usually inputs the scheduled hours of the sideline to applicant apparatus 300 after receiving an order for a new sideline, and inputs the hours spent in achieving the sideline to applicant apparatus 300 at an arbitrary timing while being engaged in the sideline. For example, when an order for a business whose assumed period is a plurality of months is received as a sideline, the applicant inputs the hours spent in achieving the sideline to applicant apparatus 300 every month.

Applicant apparatus 300 receives the input of the scheduled hours of the sideline and the hours spent in achieving the sideline (step S14). Applicant apparatus 300 transmits the received scheduled hours of the sideline and hours spent in achieving the sideline to achievement receiving unit 149 of sharing server 100.

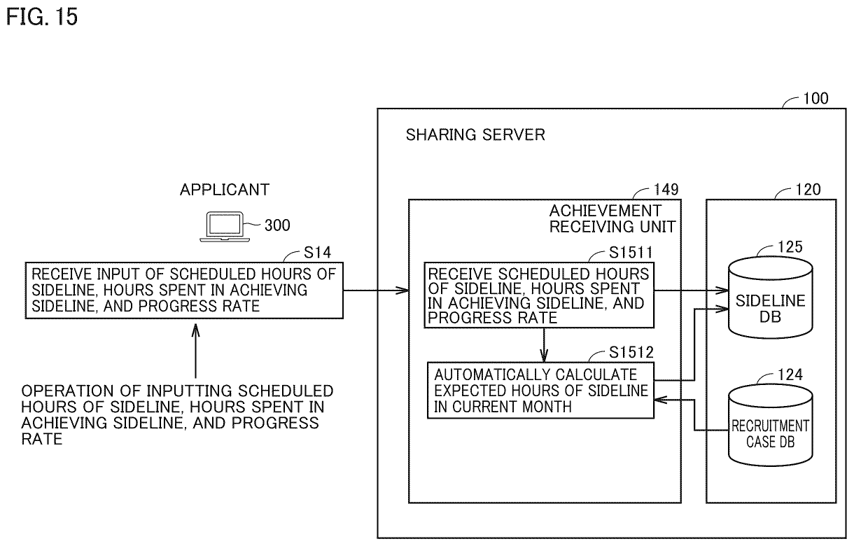

Achievement receiving unit 149 registers the received scheduled hours of the sideline and hours spent in achieving the sideline in sideline database 125. The process of step S14 and the process of achievement receiving unit 149 executed by applicant apparatus 300 will be described later in detail with reference to FIG. 15.

Achievement output unit 150 transmits the scheduled hours of the sideline and the hours spent in achieving the sideline registered in sideline database 125 to recruiter apparatus 200 and applicant apparatus 300 of the manager. Recruiter apparatus 200 displays the received information including the scheduled hours of the sideline and the hours spent in achieving the sideline on display 205, and applicant apparatus 300 of the manager displays the received information including the scheduled hours of the sideline and the hours spent in achieving the sideline on display 305 (step S15). Here, when the information transmitted to recruiter apparatus 200 is compared with the information transmitted to applicant apparatus 300 of the manager, the cases to be transmitted are different.

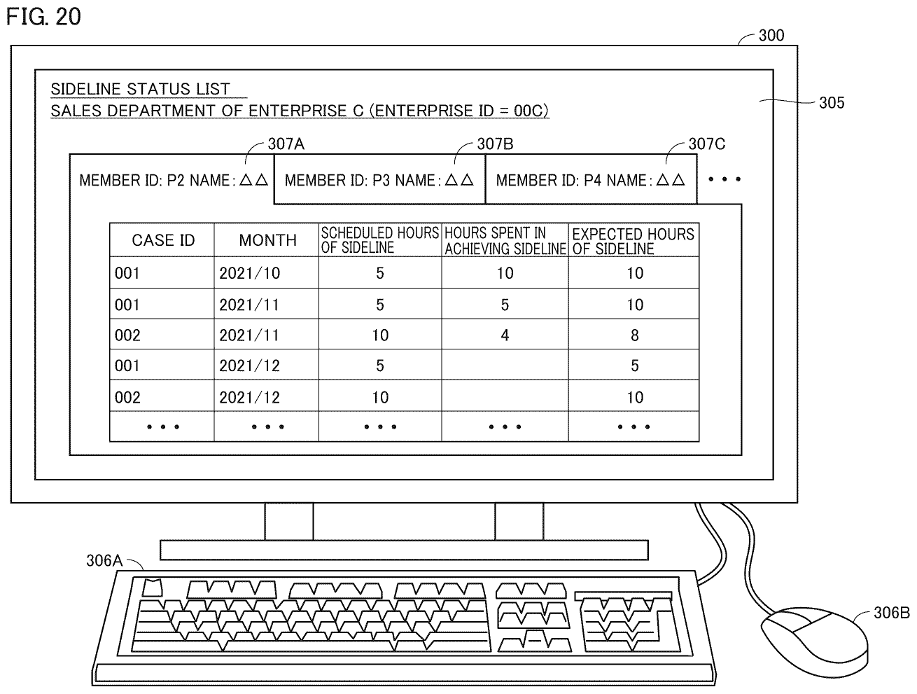

Data corresponding to the case which the subordinate is in charge of among many cases registered in sideline database 125 is transmitted from achievement receiving unit 149 to applicant apparatus 300 of the manager. The manager can check the sideline status of the subordinate by viewing display 305. A screen displayed on applicant apparatus 300 of the manager when the manager checks the sideline status of the subordinate will be described later with reference to FIG. 20.

Data corresponding to the case for which the recruiter is recruiting a vendor among many cases registered in sideline database 125 is transmitted from achievement receiving unit 149 to recruiter apparatus 200. For example, it is assumed that in sideline database 125 illustrated in FIG. 7, a first recruiter is recruiting for case 001 and a second recruiter is recruiting for case 002 among a plurality of recruiters.

In this case, various data corresponding to case 001 in sideline database 125 are transmitted from achievement receiving unit 149 to recruiter apparatus 200 operated by the first recruiter. Various data corresponding to case 002 in sideline database 125 are transmitted from achievement receiving unit 149 to recruiter apparatus 200 operated by the second recruiter.

The first recruiter and the second recruiter can check the progress status of their own cases by browsing the scheduled hours of the sideline, the hours spent in achieving the sideline, etc. displayed on display 305 of recruiter apparatus 200.

When the sideline is completed, the recruiter inputs the evaluation of the applicant to recruiter apparatus 200. Recruiter apparatus 200 receives the input evaluation (step S16). Therefore, recruiter apparatus 200 functions as an evaluator apparatus operated by the evaluator when receiving the input evaluation.

Recruiter apparatus 200 transmits the received evaluation to evaluation receiving unit 151 of sharing server 100. Evaluation receiving unit 151 updates evaluation input database 126 and evaluation summary database 127 based on the received evaluation.

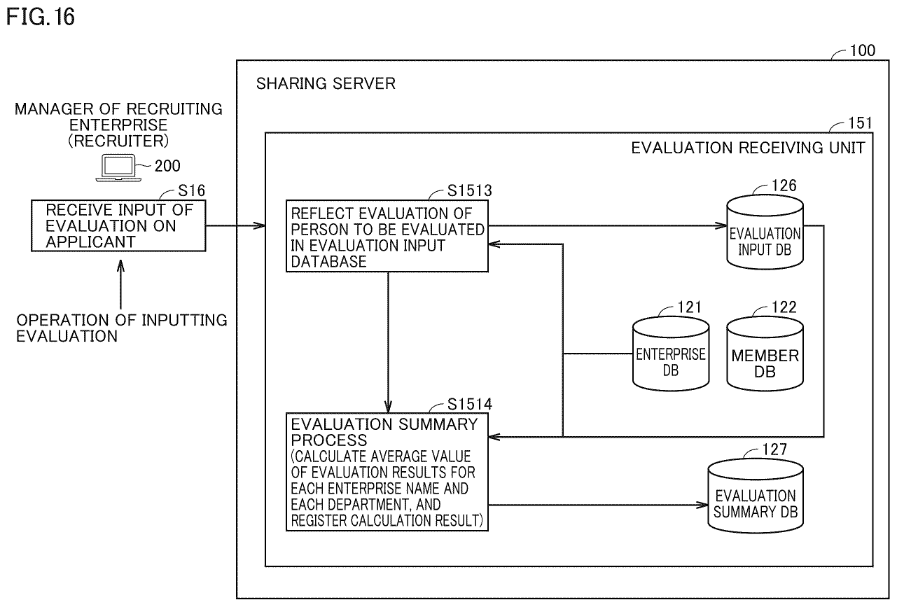

The process of step S16 and the process of evaluation receiving unit 151 executed by recruiter apparatus 200 will be described in detail later with reference to FIG. 16.

When recruiter apparatus 200 receives an operation allowing the recruiter to browse the evaluation of the applicant, recruiter apparatus 200 executes a browsing request process (step S17). In the browsing request process, recruiter apparatus 200 transmits a browsing request to evaluation output unit 152 of sharing server 100. Evaluation output unit 152 transmits the evaluation of the applicant registered in evaluation summary database 127 to recruiter apparatus 200 in response to the browsing request. Recruiter apparatus 200 displays the received evaluation of the applicant on display 205 (step S18).

The processes of step S17 and step S18 and the process of evaluation output unit 152 executed by recruiter apparatus 200 will be described in detail later with reference to FIG. 17.

### Details of Processes of Case Registration Unit and Recruiter Apparatus

FIG. 13 is a diagram illustrating a procedure of registering a recruitment case in recruitment case database 124. Step S5 in FIG. 10 and the function of case registration unit 144 will be described in more detail with reference to FIG. 13.

A recruiter who registers a recruitment case first signs in to sharing server 100 using recruiter apparatus 200. Thus, a logical communication path identified by the member ID of the recruiter is established between recruiter apparatus 200 and sharing server 100. Subsequently, the recruiter inputs the business information and disclosure information on the recruitment case to recruiter apparatus 200 using operation unit 206 such as a mouse and a keyboard.

The information input by operation unit 206 is notified to processor 201 via input and output interface 204 of recruiter apparatus 200. Operation unit 206 and input and output interface 204 constitute an interface that receives an operation of inputting the content of a business and an operation of inputting disclosure information for designating a target to which the business is disclosed.

The business information on the recruitment case includes a case title, a case content, assumed man-hours (man-months), and an assumed period. The disclosure information includes a disclosure level. The disclosure information may include an ID of an enterprise to which the disclosure information is not to be disclosed, depending on the selection of the recruiter.

Recruiter apparatus 200 receives the input of the business information and the disclosure information on the recruitment case, and executes the process of registering the recruitment case (step S5). In the process of registering the recruitment case, recruiter apparatus 200 transmits the business information and the disclosure information on the recruitment case to sharing server 100.

Case registration unit 144 of sharing server 100 acquires information on the recruiter (step S1441). Specifically, case registration unit 144 identifies an enterprise to which the recruiter belongs.

Sharing server 100 stores a member ID used for sign-in when a member signs in to sharing server 100 using recruiter apparatus 200 or applicant apparatus 300. When sharing server 100 receives some information from recruiter apparatus 200 or applicant apparatus 300 in the communication established by the member ID, sharing server 100 identifies the member who is the transmission source of the information by the member ID used for the sign-in.

Therefore, when the business information and the disclosure information on the recruitment business are received from recruiter apparatus 200, case registration unit 144 identifies the recruiter who operates recruiter apparatus 200 using the member ID used for the sign-in. Case registration unit 144 identifies the member who is the recruiter and the enterprise to which the recruiter belongs using the identified member ID, member database 122, and enterprise database 121.

Next, case registration unit 144 executes a process of registering the recruitment case in recruitment case database 124 (step S1442). Specifically, after generating a case ID, case registration unit 144 registers enterprise information (enterprise ID), an ID of a non-disclosure enterprise, a disclosure level, a case title, assumed man-hours, an assumed period, a case content, and the like in recruitment case database 124 in association with the generated case ID.

According to the present embodiment, the recruiter can freely control the disclosure range of the recruitment case at the level of “in-house”, “within community”, and “without limitation”. As a result, it is possible to prevent the disclosure of a recruitment case to a specific enterprise that the recruiter does not intend.

According to the present embodiment, a non-disclosure enterprise can be set separately from the disclosure level. Therefore, the recruiter can set the disclosure range by excluding some of the enterprises among the plurality of enterprises having a community relation with the enterprise to which the recruiter belongs. As a result, it is possible to prevent the business related to a specific enterprise in the community from being disclosed to the specific enterprise.

Instead of or in addition to the non-disclosure enterprise ID list, a non-disclosure member ID list for registering a member ID to which disclosure of the recruitment case is prohibited may be provided in recruitment case database 124. Recruiter apparatus 200 may receive an operation of designating a member to whom disclosure of the recruitment case is prohibited, and transmit the ID of the member to sharing server 100. Sharing server 100 may not provide a member corresponding to a member ID listed in the non-disclosure member ID list with a recruitment case corresponding to the list. Thus, recruiter apparatus 200 may receive either an enterprise or a member as a target to which disclosure of a business is prohibited.

FIG. 14 is a diagram for illustrating a procedure of searching for a recruitment case from database 120. The processes of step S6 and step S7 in FIG. 11 and the function of case extraction unit 145 will be described in more detail with reference to FIG. 14.

When applicant apparatus 300 receives an operation of the applicant requesting a search for a recruitment case, applicant apparatus 300 executes a search process for the recruitment case (step S6). In the search process for the recruitment case, applicant apparatus 300 transmits a search request to case extraction unit 145 of sharing server 100.

When case extraction unit 145 receives the search request, case extraction unit 145 extracts cases allowed to be browsed by the applicant from the recruitment cases registered in recruitment case database 124. For this purpose, case extraction unit 145 executes the processes of steps S1451 to S1454.

Steps S1451 and S1452 are processes for extracting cases that are allowed to be browsed by the applicant based on the disclosure range set in the recruitment case. In step S1451, the enterprise to which the applicant belongs and the community of the enterprise to which the applicant belongs are determined. In step S1452, a case that can be disclosed is extracted.

Step S1453 is a process of extracting a case which is allowed to be browsed by the applicant based on the available capacity for sideline of the applicant. Step S1454 is a process of finally extracting a case matching the applicant.

### Process of Extracting Case Based on Disclosure Range

Step S1451 includes step S1451A and step S1451B.

In step S1451A, the enterprise to which the applicant belongs is identified based on the member ID used in the sign-in, enterprise database 121, and member database 122.

In step S1451B, the community of the enterprise to which the applicant belongs is identified based on the ID of the enterprise to which the applicant belongs and community database 123.

Step S1452 includes step S1452A and step S1452B.

In step S1452A, a recruitment case which can be disclosed is extracted from recruitment case database 124 based on the community of the enterprise to which the applicant belongs and the disclosure level.

In step S1452B, the recruitment case, in which the enterprise to which the applicant belongs is present in the non-disclosure enterprise list, is excluded from the recruitment cases extracted in step S1452A. Here, the case extracted by the process of step S1452B is referred to as case X.

### Process of Extracting Case Based on Available Capacity for Sideline

Step S1453 includes step S1453A, step S1453B, and step S1453C.

In step S1453A, hours T1 available for sideline of the applicant are calculated. The hours available for sideline are derived by calculating “maximum sideline hours-total sideline hours”. The maximum sideline hours are hours determined by the enterprise to which the applicant belongs, and are registered in enterprise database 121. The calculated hours available for sideline are registered in member database 122. Case extraction unit 145 may calculate the hours available for sideline of all the members at a constant time interval and register the calculated hours available for sideline in member database 122.

The total sideline hours are calculated based on a calculation formula of “total expected hours of the sidelines+total hours spent in achieving the sidelines” based on the expected hours of the sidelines and the hours spent in achieving the sidelines registered in sideline database 125. That is, the total sideline hours include the hours already spent on the sidelines and the expected hours not yet spent on the sidelines.

In step S1453B, hours T2 for handling the business are calculated for each of the recruitment cases. Hours T2 are calculated based on the assumed man-hours (man-months) and the assumed period registered in recruitment case database 124. For example, the hours of the assumed man-hours (man-months) may be adopted as hours T2. For example, 5 hours per month may be set as hours T2 for the recruitment case corresponding to case ID001.

In step S1453C, the recruitment case corresponding to “hours T2≤ hours T1 available for sideline” is extracted from recruitment case database 124. Here, the case extracted by the process of step S1453C is referred to as case Y.

### Process of Extracting Case Based on Disclosure Range and Available Capacity for Sideline

Case extraction unit 145 extracts case X based on the disclosure range, extracts case Y based on the available capacity for sideline, and then extracts cases overlapping between case X and case Y as matching cases of the applicant (step S1454).

### Process of Providing Extracted Cases

Next, case extraction unit 145 transmits information on the matching cases to applicant apparatus 300 (step S1455). Applicant apparatus 300 receives the matching cases. Applicant apparatus 300 displays a list of the received matching cases as recruitment cases on display 305 (step S7).

Thus, the recruitment cases which are suitable for the applicant are provided from two viewpoints. That is, first, a recruitment case that can be handled within a range which does not exceed the maximum sideline hours of the applicant is provided to the applicant. This can prevent the applicant from falling into an overworked state. Second, a recruitment case of the recruiter is provided only to the applicants belonging to the disclosure range intended by the recruiter. Thus, the confidential information on the enterprise to which the recruiter belongs can be prevented from leaking to a competitor.

### Process of Registering Scheduled Hours of Sideline and Hours Spent in Achieving Sideline

FIG. 15 is a diagram illustrating a procedure of registering a schedule and an achievement of a sideline in database 120. Step S14 and the function of achievement receiving unit 149 in FIG. 12 will be described in more detail with reference to FIG. 15.

The applicant, for example, inputs the scheduled hours of the sideline to applicant apparatus 300 after receiving an order for a new sideline, and inputs the hours spent in achieving the sideline to applicant apparatus 300 at an arbitrary timing while being engaged in the sideline. Applicant apparatus 300 receives the input of the scheduled hours of the sideline (step S14). Applicant apparatus 300 transmits the received scheduled hours of the sideline and hours spent in achieving the sideline to achievement receiving unit 149 of sharing server 100.

Achievement receiving unit 149 receives the scheduled hours of the sideline and the hours spent in achieving the sideline of the applicant, and registers the received scheduled hours of the sideline and hours spent in achieving the sideline of the applicant in sideline database 125 (step S1511). Thus, the monthly scheduled hours of the sideline and hours spent in achieving the sideline of the applicant are registered in sideline database 125 for each case ID.

Usually, after the applicant inputs the scheduled hours of the sideline, the applicant inputs the hours spent in achieving the sideline at the end of the month. Therefore, sideline database 125 may include a case in which the scheduled hours of the sideline are registered but the hours spent in achieving the sideline are not registered. For example, at the stage when the applicant who has received an order for a sideline has input the scheduled hours of the sideline, the scheduled hours of the sideline are registered as data corresponding to the sideline, but the hours spent in achieving the sideline are not registered.

Next, achievement receiving unit 149 automatically calculates the expected hours of the sideline in the current month (step S1512). Achievement receiving unit 149 calculates the expected hours of the sideline based on the scheduled hours of the sideline and the hours spent in achieving the sideline. Specifically, as already described, the “expected hours of the sideline” is calculated based on the calculation formula of “(man-hour progress rate/progress rate)×scheduled hours of the sideline-hours spent in achieving the sideline”. Achievement receiving unit 149 may calculate the “expected hours of the sideline” based on a calculation formula of “scheduled hours of the sideline-hours spent in achieving the sideline”. Achievement receiving unit 149 registers the calculated expected hours of the sideline in sideline database 125. As illustrated in sideline database 125 of FIG. 7, the expected hours of the sideline are registered for each case ID.

### Process of Registering Evaluation Result

FIG. 16 is a diagram illustrating a procedure of registering an evaluation of an applicant in database 120. Step S16 and the function of evaluation receiving unit 151 in FIG. 12 will be described in more detail with reference to FIG. 16.

When the applicant completes the sideline, the applicant reports the delivery and completion to the recruiter, and receives inspection from the recruiter. Thereafter, the recruiter operates recruiter apparatus 200 to input the evaluation of the applicant to recruiter apparatus 200. Recruiter apparatus 200 receives the input evaluation (step S16). Recruiter apparatus 200 transmits the received evaluation to evaluation receiving unit 151 of sharing server 100. The information transmitted from recruiter apparatus 200 to sharing server 100 includes the member ID and an evaluation value (0 to 10) of the applicant who is the person to be evaluated.

When evaluation receiving unit 151 receives the information on the evaluation of the person to be evaluated from recruiter apparatus 200, evaluation receiving unit 151 reflects the evaluation of the person to be evaluated in evaluation input database 126 (step S1513).

When an evaluation result of the recruiter (evaluator) for the person to be evaluated has already been registered in evaluation input database 126, evaluation receiving unit 151 calculates the average value of the evaluation results of the evaluator for the person to be evaluated including the value of the evaluation received this time. Evaluation receiving unit 151 updates the evaluation result registered in evaluation input database 126 with the calculated average value. As a result, the average value of the evaluation (evaluation result) for the person to be evaluated is registered in evaluation input database 126 for each evaluator.

Next, evaluation receiving unit 151 executes an evaluation summary process (step S1514). In the evaluation summary process, evaluation receiving unit 151 calculates an average value of the evaluation results for the person to be evaluated for each enterprise and each department, and registers the calculation result in evaluation summary database 127.

For example, evaluation receiving unit 151 identifies the evaluator using the member ID which is used by recruiter apparatus 200 for sign-in to execute step S16. Evaluation receiving unit 151 identifies the ID of the enterprise to which the evaluator belongs, the department to which the evaluator belongs, the member ID of the person to be evaluated, and the ID of the enterprise to which the person to be evaluated belongs, based on the information on the evaluation received in step S1513, enterprise database 121, and member database 122. The “member ID” is an example of “identification information that enables sharing server 100 including evaluation receiving unit 151 to identify the affiliation (enterprise and department) of a person who has accessed sharing server 100”.

Evaluation receiving unit 151 accesses evaluation summary database 127 and detects a data row in which the identified IDs (the member ID of the person to be evaluated, the ID of the enterprise to which the person to be evaluated belongs, and the ID of the enterprise to which the evaluator belongs) are arranged. Evaluation receiving unit 151 updates the value of the evaluation summary corresponding to the detected data row.

For example, in data group 127A of FIG. 9, the member ID of the person to be evaluated=P7, the ID of the enterprise to which the person to be evaluated belongs=00C, and the ID of the enterprise to which the evaluator belongs=00A are arranged. When a member belonging to the system department of enterprise A evaluates member P7, the evaluation is received in step S1513.

In this case, in step S1514, the evaluation received in step S1513 is reflected in the evaluation summary corresponding to “all” and the evaluation summary corresponding to “system department” of data group 127A.

More specifically, evaluation receiving unit 151 sets the average value of the evaluations of entire enterprise C including the evaluation received in step S1513 as the evaluation summary corresponding to “all” of data group 127A. Similarly, evaluation receiving unit 151 sets the average value of the evaluations of the system department including the evaluation received in step S1513 as the evaluation summary corresponding to “system department” of data group 127A.

FIG. 17 is a diagram illustrating a procedure of displaying an evaluation for an applicant and a search result of a member on display 305. Step S4 (process of recruiter apparatus 200) and the function of member search unit 143 in FIG. 10, and step S17 and the function of evaluation output unit 152 in FIG. 12 will be described in more detail with reference to FIG. 17.

### Process of Outputting Evaluation Summary of Applicant

When recruiter apparatus 200 receives an operation allowing the recruiter to browse the evaluation of the applicant, recruiter apparatus 200 executes a browsing request process (step S17). In the browsing request process, recruiter apparatus 200 transmits a browsing request to evaluation output unit 152 of sharing server 100. In response to the browsing request, evaluation output unit 152 selects an evaluation summary for which the recruiter (browsing requester) has the browsing authority from evaluation summary database 127 (step S1521).

The recruiter who has made the browsing request is authorized to browse the evaluation summary of the entire enterprise to which the recruiter belongs and the evaluation summary of the department to which the recruiter belongs. The recruiter who has made the browsing request is not authorized to browse evaluation summaries other than these. Evaluation output unit 152 determines the browsing authority based on the member ID of the recruiter who transmits the browsing request, enterprise database 121, and member database 122. The “member ID” is an example of “identification information that enables sharing server 100 including evaluation receiving unit 151 to identify the affiliation (enterprise and department) and the browsing authority of a person who has accessed sharing server 100.”

Evaluation output unit 152 selects an evaluation summary corresponding to the browsing authority from evaluation summary database 127. Evaluation output unit 152 transmits data including the selected evaluation summary to recruiter apparatus 200 (step S1522). The transmitted data includes the member ID of the applicant (person to be evaluated), information on the enterprise to which the applicant belongs, information on the department to which the applicant belongs, and the like, in addition to the evaluation summary. When there is a selection target of evaluation output unit 152, the transmitted data includes evaluation summaries corresponding respectively to a plurality of applicants (persons to be evaluated).

Recruiter apparatus 200 which has received the evaluation summary displays the evaluation summary of the applicant on display 205 together with information on the enterprise to which the applicant belongs and information on the department to which the applicant belongs (step S18). When the evaluation summaries corresponding respectively to the plurality of applicants (persons to be evaluated) are received, recruiter apparatus 200 displays the evaluation summaries by listing the plurality of applicants (persons to be evaluated).

Thus, when sharing server 100 receives a browsing request in communication established by a member ID by which an enterprise and a department to which a recruiter belongs can be identified, sharing server 100 transmits an evaluation summary as an example of evaluation information to recruiter apparatus 200 of the recruiter who is a transmission source that has transmitted the browsing request.

### Process of Searching Member

Recruiter apparatus 200 executes a member search process after receiving a search operation by a person who recruits a vendor for a business (step S4). In the member search process, recruiter apparatus 200 transmits a search request to member search unit 143 of sharing server 100. For example, the search request includes a reference value for excluding members with low evaluation in the member search.

Member search unit 143 that has received the search request identifies the enterprise to which the recruiter who has transmitted the search request belongs (step S1431). Here, the enterprise identified in step S1431 is referred to as “enterprise X”.

Member search unit 143 identifies the recruiter who operates recruiter apparatus 200 using the member ID which is used when recruiter apparatus 200 signs in to sharing server 100. Member search unit 143 identifies enterprise X to which the recruiter belongs using enterprise database 121 and member database 122.

Next, member search unit 143 extracts members whose value of the evaluation summary of entire identified enterprise X exceeds the reference value from evaluation summary database 127 (step S1432). That is, member search unit 143 excludes members having low evaluation of entire enterprise X to extract a search result. Sharing server 100 may have a function of receiving setting information on the reference value from recruiter apparatus 200 of each enterprise. Thus, each enterprise can exclude members having low evaluation based on its own reference value from the search result.

Next, member search unit 143 outputs the extracted member information as a search result to recruiter apparatus 200 that has made the search request (step S1433). Recruiter apparatus 200 displays the received search result in a list on display 205 (step S19).

As a result, the recruiter can browse the search result excluding members with low overall evaluation of the enterprise to which the recruiter belongs on display 205. Therefore, when selecting a vendor from applicants, the recruiter can save the trouble of visually excluding members whose overall evaluation of the enterprise is low.

According to the present embodiment, when a member has a low evaluation in a certain department of the enterprise to which the recruiter belongs, the member is still not excluded from the search result if the evaluation of the entire enterprise is not low. However, member search unit 143 may further exclude such members from the search result.

### Browsable Range of Evaluation Summary Database

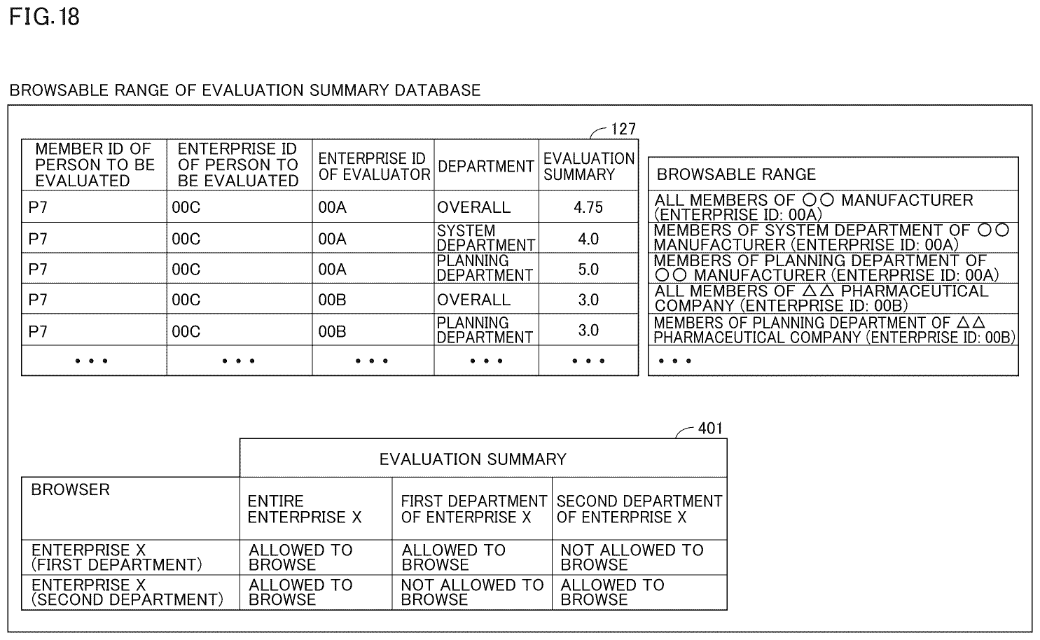

FIG. 18 is a diagram illustrating a browsable range of evaluation summary database 127. As illustrated in FIG. 18, the browsing authority for the evaluation summary calculated from the evaluation of entire enterprise A is granted to all the members (recruiters) belonging to enterprise A.

The browsing authority for the evaluation summary calculated from the evaluation of the system department of enterprise A is granted to the members (recruiters) of the system department of enterprise A, but not granted to the members (recruiters) other than the system department of enterprise A. The browsing authority for the evaluation summary calculated from the evaluation of the planning department of enterprise A is granted to the members (recruiters) of the planning department of enterprise A, but not granted to the members (recruiters) other than the planning department of enterprise A.

The browsing authority for the evaluation summary calculated from the evaluation of entire enterprise B is granted to all the members (recruiters) belonging to enterprise B. The browsing authority for the evaluation summary calculated from the evaluation of the planning department of enterprise B is granted to the members (recruiters) of the planning department of enterprise B, but not granted to the members (recruiters) other than the planning department of enterprise B.

When the browsers are a member (recruiter) of the first department of enterprise X and a member (recruiter) of the second department of enterprise X, the browsers' authorities for the evaluation summary of entire enterprise X, the evaluation summary of the first department of enterprise X, and the evaluation summary of the second department of enterprise X are as illustrated in Table 401 of FIG. 18.

The evaluation summary of entire enterprise X, the evaluation summary of the first department of enterprise X, and the evaluation summary of the second department of enterprise X are shared by enterprise X, but are not disclosed to members of enterprises other than enterprise X. Therefore, for example, even when an employee of enterprise Y who has contracted the recruitment business of enterprise X has not performed the job well, the recruiter of enterprise X can evaluate the employee of enterprise Y by an objective scale without considering the relation between the enterprises, etc.

Further, since the evaluation is shared in enterprise X as an evaluation summary, the evaluator can be made aware that the accumulation of evaluations one by one produces useful information. This provides the evaluator with a motivation to make an accurate evaluation. As a result, the accuracy of the evaluation summary is improved. Thus, the evaluation summary can be usefully leveraged as reference data for selecting a vendor.

Further, according to the present embodiment, when the member search process (step S4) is executed in recruiter apparatus 200, the search result excluding the members with low evaluation is provided to the recruiter (step S1432). That is, matching system 1 has a filtering function of providing a search result excluding members with low evaluation.

Therefore, the recruiter can prevent the members with low evaluation from being adopted by mistake on an enterprise-by-enterprise basis when determining the vendor for the recruitment business. Sharing server 100 may perform filtering using the evaluation summary for each department.

A command signal for commanding which of filtering using the evaluation summary of the entire enterprise and filtering using the evaluation summary of each department is used may be transmitted from recruiter apparatus 200 to sharing server 100. In this case, sharing server 100 is provided with a function of changing the evaluation summary used for filtering in response to the command signal.

Example in which Disclosure Range is Set in Accordance with Disclosure Level

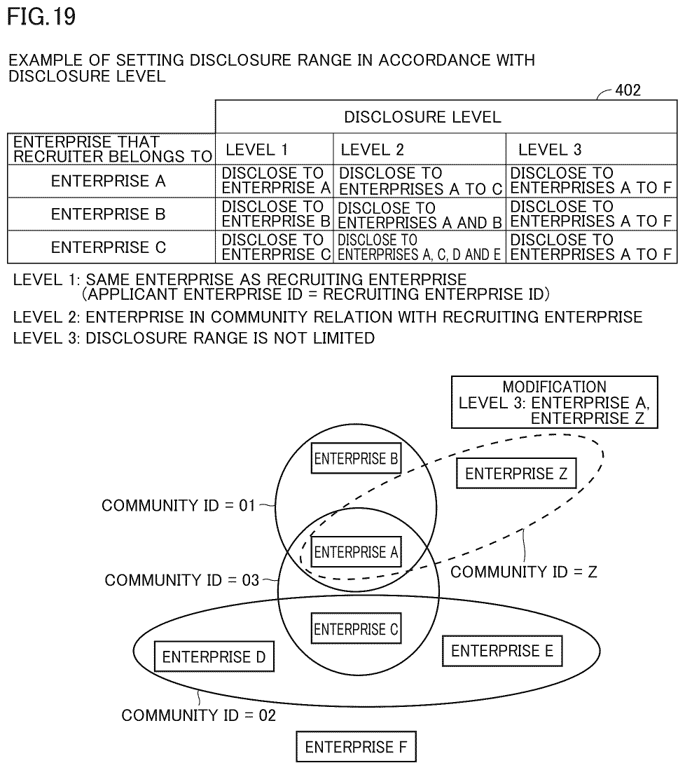

FIG. 19 is a diagram illustrating an example in which a disclosure range is set in accordance with a disclosure level. Here, as illustrated in FIG. 19, a case where enterprises A to E form a community relation and enterprise F does not have a community relation with any enterprise is considered. In this case, the disclosure range of the recruitment case is as illustrated in Table 402 in accordance with the enterprise to which the recruiter belongs and the disclosure level set by the recruiter.

The disclosure levels of “level 1” to “level 3” illustrated in FIG. 19 correspond to the three levels of “in-house”, “within community”, and “all” described above. Therefore, at level 1, the recruitment case of the recruiter is disclosed only to the applicants of the same enterprise as the enterprise to which the recruiter belongs. At level 2, in addition to the range of level 1, the recruitment case of the recruiter is disclosed to the applicants who belong to an enterprise having a community relation with the enterprise to which the recruiter belongs. At level 3, the recruitment case of the recruiter is disclosed to applicants belonging to all enterprises including the enterprise to which the recruiter belongs. Here, when the recruiter designates an ID of a non-disclosure enterprise, the enterprise corresponding to the enterprise ID is excluded from the enterprises which are disclosure targets regardless of the set disclosure level. Among the disclosure levels of the present embodiment, “level 1” corresponds to “allowing disclosure of the business information to the first applicant and prohibiting disclosure of the business information to an applicant who does not belong to the first group”. “Level 2” corresponds to “allowing disclosure of the business information to an applicant belonging to either the first group or a community group having a community relation formed with the first group, and prohibiting disclosure of the business information to an applicant not belonging to either the first group or the community group”. “Level 3” corresponds to “allowing disclosure of the business information to the applicant regardless of the group to which the applicant belongs”.

Here, as an example of a plurality of types of disclosure levels, the above level 1 to level 3 have been described. However, a plurality of types of disclosure levels is not limited to these. For example, a community may be divided into a plurality of small communities, and whether or not to disclose the recruitment business may be set for each small community. More specifically, community 02 illustrated in FIG. 5 is divided into a first small community and a second small community. It is assumed that enterprise C belongs to the first small community and enterprises D and E belong to the second small community. In this case, the recruiter of enterprise D may be allowed to select either the range of the first small community or the range of the second small community as the disclosure range of the recruitment business of the recruiter.

Sharing server 100 may receive an operation of setting the disclosure range differently for each recruitment case. For example, a specific example in which the disclosure range is set differently for each recruitment case will be described by taking case 001 to case 003 as examples among a large number of recruitment cases.

For example, the disclosure range of recruitment case 001 may be limited to only enterprises A and C belonging to the community identified by community ID=03. Alternatively, the disclosure range of recruitment case 002 may be limited to only enterprises C and D belonging to the community identified by community ID=02. Alternatively, the disclosure range of case 003 may be limited to enterprises C, D, and C belonging to the community identified by community ID=02 and enterprises A and C belonging to the community identified by community ID=03.

Enterprise A may form a community different from the community identified by community ID=01 or 02. For example, as indicated by a broken line in FIG. 19, enterprise A may form a community identified by community ID=Z with enterprise Z. For example, when the recruiter belongs to enterprise A, the recruitment case of the recruiter may be disclosed to applicants belonging to enterprise A and applicants belonging to enterprise Z. Such a level of disclosure may be employed as a modification of “level 3” as illustrated in FIG. 19.

In this case, “level 3” corresponds to “allowing disclosure of the business information to applicants belonging to a specific community group (community identified by community ID=Z) different from the first group (enterprise A) and community groups of the second level (enterprise A to enterprise C) having community relations formed with the first group, and prohibiting disclosure of the business information to applicants not belonging to either the first group or the specific community group”.

Screen Example Displayed when Checking Sideline Status

FIG. 20 is a diagram illustrating a screen displayed on applicant apparatus 300 of a manager when the manager (a superior of an applicant) checks a subordinate's sideline status. FIG. 20 shows an example in which the sideline status of the subordinate of the manager is displayed on applicant apparatus 300. Applicant apparatus 300 is provided with a keyboard 306A and a mouse 306B as an operation unit.

Here, the manager is, for example, a department manager of a sales department of enterprise C. Display 305 shows the sideline status of the employees belonging to the sales department. The manager can check the sideline status of the employees belonging to the sales department by designating any of a tab 307A, a tab 307B, a tab 307C . . . using keyboard 306A or mouse 306B. Therefore, the manager can manage the working hours of the subordinates so that the subordinates do not fall into an overworked state. The progress rate may also be displayed on the screen.

The “group by enterprise” and the “group by department in the same enterprise” in the present embodiment are examples of “group.” Applicants who do not belong to the enterprise, such as freelances, may constitute one “group.” A plurality of enterprises may constitute an “enterprise group.”

According to the present embodiment, the “enterprises that form a community relation” are an example of “community group.”

According to the present embodiment, the information on “non-disclosure target” included in the disclosure information is an example of “information that can be used to identify a target for whom disclosure of the business information is prohibited”.

The communication (S9 in FIG. 11) for transmitting approval information from applicant apparatus 300 of the manager functioning as an approver to approval unit 147 is performed in a logical communication path identified by the member ID of the approver.” Approval unit 147 receiving the approval information through such a communication path” is an example of “receiving the approval notification through communication involving the identification information on the approver of the first applicant.”

According to the present embodiment, the “evaluation summary” registered in evaluation summary database 127 is an example of “evaluation information based on the evaluation received from recruiter apparatus 200 functioning as an evaluator apparatus.”

According to the present embodiment, “recruiter apparatus 200A” operated by a recruiter belonging to enterprise A functions as an evaluator apparatus, and is an example of “first evaluator apparatus operated by one or more evaluators belonging to the first group.”

According to the present embodiment, “recruiter apparatus 200B” operated by a recruiter belonging to enterprise B functions as an evaluator apparatus, and is an example of “second evaluator apparatus operated by one or more evaluators belonging to a second group different from the first group”.

FIG. 18 illustrates a system department and a planning department as the departments of enterprise A. According to the present embodiment, “one of the system department and the planning department” is an example of “first division group” included in the first group, and the other is an example of “second division group” included in the first group.

Sharing server 100 extracts business information in which the working hours of the applicant do not exceed the maximum hours from the list of recruitment case database 124 based on the assumed man-hours registered in recruitment case database 124, the maximum sideline hours registered in enterprise database 121, the hours spent in achieving the sideline registered in sideline database 125, and the expected hours of the sideline registered in sideline database 125. Specifically, for example, when the applicant is engaged in a plurality of sidelines, sharing server 100 calculates a total value of the hours spent in achieving the sidelines corresponding respectively to the sidelines to obtain the total hours spent in achieving the sidelines, and calculates a total value of the expected hours of the sidelines corresponding respectively to the sidelines to obtain the total expected hours of the sidelines. Sharing server 100 adds the obtained total hours spent in achieving the sidelines and the obtained total expected hours of the sidelines to obtain the total sideline hours. Sharing server 100 obtains the hours available for sideline of the applicant by subtracting the total sideline hours from the maximum sideline hours of the applicant. Sharing server 100 searches the list of recruitment case database 124 for a case that can be handled in the obtained hours available for sideline. At this time, sharing server 100 calculates the hours for handling each of the recruitment cases based on the assumed man-hours of recruitment case database 124, and searches for recruitment cases within the range of the hours available for sideline. Here, the “maximum sideline hours” is an example of “maximum hours as the upper limit of the working hours of the applicant,” the “hours spent in achieving the sideline” is an example of “actual hours during which the applicant has worked to achieve the sideline,” and the “expected hours of the sideline” is an example of “hours which are expected to be the working hours of the applicant.” The maximum hours may be a set upper limit to the total hours of the main business hours and the sideline hours, rather than to the sideline hours only. First maximum hours may be the maximum hours for all the businesses including the main business and the sidelines, rather than the maximum sideline hours. First actual hours and first expected hours may be the total hours of all the businesses including the sidelines and the main business, rather than sideline hours only.

Recruiter apparatus 200 and applicant apparatus 300 may be thin client systems, etc. that utilize a virtual desktop infrastructure (VDI), as well as systems including all of the processor, the memory, the communication interface, and the input and output interface illustrated in FIG. 2. A thin client system utilizing VDI is a system in which a desktop environment on a server is transferred to a terminal at a remote location and utilized. Recruiter apparatus 200, applicant apparatus 300, and sharing server 100 are not necessarily independent apparatuses. When the thin client system described above is utilized, the functions of recruiter apparatus 200, applicant apparatus 300, and sharing server 100 can be provided on the same aggregation server.

Database 120 is not limited to a relational database, and may be an object-type database, a NoSQL-type database, or the like.

Sharing server 100 is an example of a computing apparatus. The computing apparatus may be configured of a server (an on-premises server, a cloud server, or the like), a serverless system, or the like. Here, the on-premises server is a server that is installed and managed in a facility managed within the enterprise. The cloud server is a server (borrowed server) provided by another business operator via a network. The serverless system is a system in which a computing memory function can be utilized without being aware of the presence of a server. The computing apparatus includes servers and serverless systems. The server includes on-premises servers and cloud servers.

### Modification 1

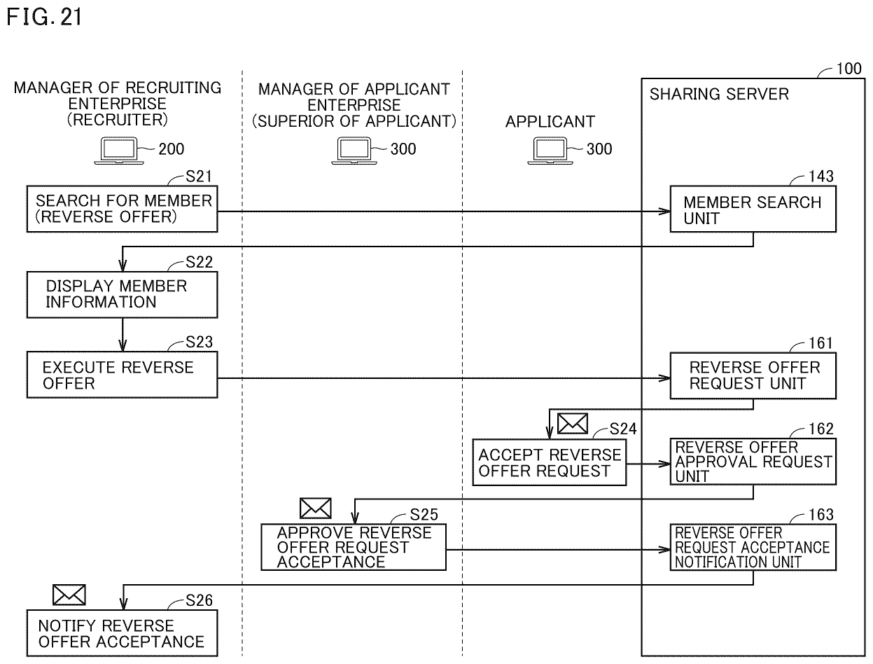

Next, Modification 1 will be described with reference to FIGS. 21 to 23. Modification 1 describes a reverse offer function that allows a recruiter to urge a person selected from a large number of members to join a recruitment business.

### Background of Proposing Reverse Offer Function

In crowdsourcing, generally, a recruiter discloses information on a recruitment case and waits for an application from a person who is interested in the content of the recruitment case. However, in such a method of recruiting, it may take time until a response is received from an applicant. Further, it is not clear whether or not there is an application from a person having a skill expected by the recruiter.

Therefore, it is conceivable that the recruiter searches for members and designates an appropriate member (reverse offer). However, it is difficult for the recruiter to designate a truly desired applicant in a state where only member IDs and names of the members are known to the recruiter. In addition, in order to prevent confidential information from leaking to enterprises or the like in a rival relation, member information on enterprises or the like in a rival relation must be excluded from the search result.

In view of such a background, according to Modification 1, a search result including detailed profile information on a member is provided to a recruiter who has performed a member search. Further, according to Modification 1, member information on an enterprise or the like having a rival relation with the enterprise or the like to which the recruiter belongs is excluded from the search result. Hereinafter, Modification 1 will be described in detail with reference to the drawings.

FIG. 21 is a diagram illustrating functions of sharing server 100, recruiter apparatus 200, and applicant apparatus 300 according to Modification 1.

As illustrated in FIG. 21, sharing server 100 functionally includes a reverse offer request unit 161, a reverse offer approval request unit 162, and a reverse offer request acceptance notification unit 163 in addition to member search unit 143. These various functions are implemented by processor 101, memory 102, storage 103, and communication interface 104 included in sharing server 100.

Member search unit 143, as already described, has a function of searching for a member of matching system 1. In particular, according to Modification 1, member search unit 143 has a function of providing detailed profile information on the member to the searcher. Recruiter apparatus 200 executes a member search process after receiving a search operation by a recruiter (step S21). In particular, in step S21, recruiter apparatus 200 receives a search operation for the recruiter to make a reverse offer. Member search unit 143 provides information on members registered in member database 122 to recruiter apparatus 200. The information on the members to be provided includes detailed profile information on the members. Here, member search unit 143 excludes member information on an enterprise or the like having a rival relation with the enterprise or the like to which the recruiter belongs from the search result.

Recruiter apparatus 200 receives the member information (search result) from member search unit 143, and displays the member information as the search result on display 205 (step S22). Thereafter, recruiter apparatus 200 receives an operation of selecting an applicant from the search result by the recruiter. That is, the recruiter selects a member to whom a reverse offer is to be made based on the search result, and operates recruiter apparatus 200 to execute the reverse offer (step S23). Recruiter apparatus 200 transmits the member ID of the member who is the target of the reverse offer to sharing server 100.

Reverse offer request unit 161 receives the member ID of the member who is the target of the reverse offer from recruiter apparatus 200. Reverse offer request unit 161 identifies the member corresponding to the received member ID. Reverse offer request unit 161 notifies applicant apparatus 300 of the member who is the target of the reverse offer that the request of the reverse offer has been received. This notification may include information on the recruitment case which is the target of the reverse offer. The member who is the target of the reverse offer receives the request of the reverse offer through applicant apparatus 300. The “request” received here is an example of “information for urging the applicant to apply.” The member who is the target of the reverse offer determines whether or not to accept the request of the reverse offer. The member who is the target of the reverse offer can perform an operation of accepting the request of the reverse offer or an operation of rejecting the request of the reverse offer using applicant apparatus 300. Applicant apparatus 300 accepts the request of the reverse offer, for example (step S24). Applicant apparatus 300 that has accepted the request of the reverse offer transmits the application information to reverse offer approval request unit 162.

Reverse offer approval request unit 162 transmits the application information on the subordinate to the superior of the applicant. Reverse offer approval request unit 162 identifies the member ID of the superior who is the manager of the applicant based on the relation between the member ID of the applicant and the member ID of the superior registered in member database 122. The superior of the applicant checks the application information and approves the application on the superior's applicant apparatus 300 (step S25).

Reverse offer request acceptance notification unit 163 receives approval information from the superior of the applicant. Reverse offer request acceptance notification unit 163 accepts the application of the applicant on condition that the approval information is received. Reverse offer request acceptance notification unit 163 notifies recruiter apparatus 200 that the application from the member who has executed the reverse offer has been accepted. Recruiter apparatus 200 notifies the recruiter that the reverse offer has been accepted based on the notification (step S26). More specifically, recruiter apparatus 200 displays information for notifying the recruiter that the reverse offer has been accepted on display 205.

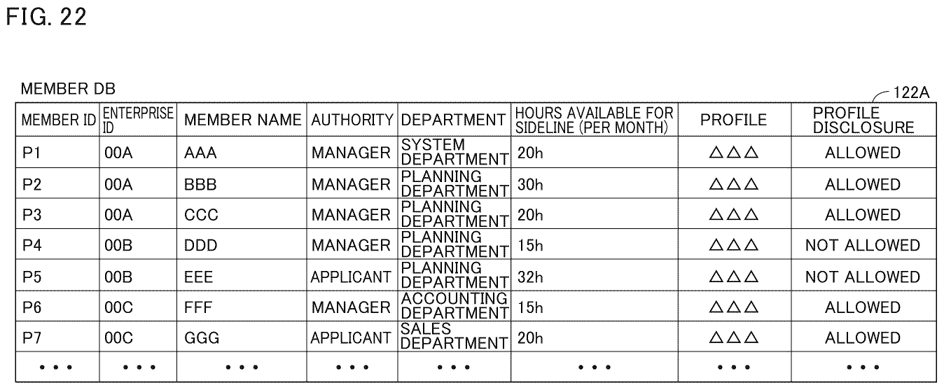

FIG. 22 is a diagram illustrating an example of member database 122A according to Modification 1. Compared to member database 122 illustrated in FIG. 4, member database 122A illustrated in FIG. 22 has added profile information and profile public information indicating whether or not to make the profile public.

Matching system 1 gives the member the authority to register and modify the member's profile information in member database 122A using applicant apparatus 300. The member registers various profile information on the member in member database 122A using applicant apparatus 300. The profile information includes, for example, information on a synthetic personality inventory (SPI) of the member, a job history of the member, achievements of the member, qualifications of the member, etc.

The member sets the profile public information using applicant apparatus 300. The profile information on the member whose profile public information is set to allow disclosure is provided to the searcher. The profile information on the member whose profile public information is set to forbid disclosure is not provided to the searcher. Sharing server 100 registers the profile public information in member database 122A based on the setting selected by each member. Thus, sharing server 100 receives an input of information indicating whether or not to allow the inclusion of profile information in the search result from each of a plurality of members.

Here, an example, in which whether or not the disclosure of the profile information on the member is allowed is determined based on the setting of the profile public information, has been described. However, sharing server 100 may receive a setting operation of whether to allow disclosure for each type of profile information. Thus, for example, the member can set the achievements and qualifications as disclosure targets, while set the information on the SPI as a non-disclosure target. Alternatively, when age is included in the profile information, the member can set the age as a non-disclosure target and set the other profile information as disclosure targets. In this case, sharing server 100 registers a plurality of pieces of profile information on each of a plurality of registrants (members) in member database 122A. Sharing server 100 receives an input for setting a range to be disclosed as a search result among the plurality of pieces of profile information from each of the plurality of registrants.

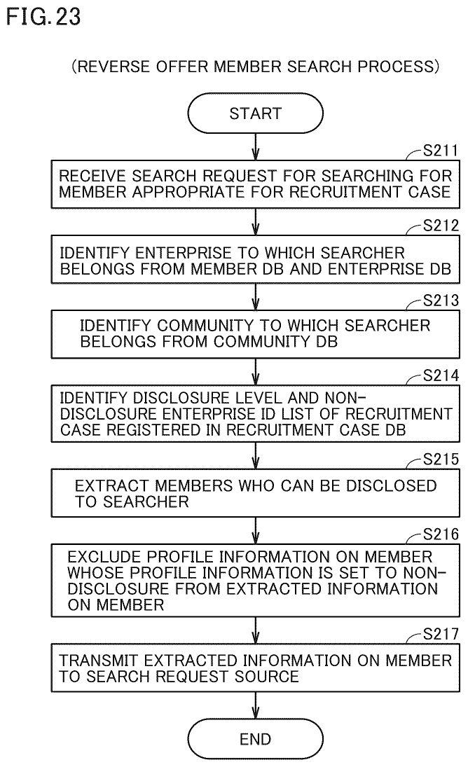

FIG. 23 is a flowchart illustrating a processing procedure of a reverse offer member search process according to Modification 1. The process based on the flowchart is executed by sharing server 100.

First, sharing server 100 receives a search request for a searcher to search for a member appropriate for a recruitment case (step S211). Here, the searcher is a recruiter who has a recruitment case. The recruiter searches for members using the recruiter's recruiter apparatus 200 in order to make a reverse offer to a member having a skill appropriate for the recruitment case. The search request of the recruiter is received by sharing server 100 in step S211. The search request may include the member ID of the searcher and the case ID of the recruitment case.

Next, sharing server 100 identifies the enterprise to which the searcher belongs from member database 122A and enterprise database 121 (step S212). Next, sharing server 100 identifies the community to which the searcher belongs from community database 123 (step S213).

Next, sharing server 100 identifies the disclosure level and the non-disclosure enterprise ID list of the recruitment case registered in recruitment case database 124 (step S214). Next, sharing server 100 extracts members who can be disclosed to the searcher (step S215).

More specifically, sharing server 100 identifies enterprises, to which the recruitment case held by the searcher (recruiter) should not be disclosed, based on the non-disclosure enterprise list and the disclosure level of recruitment case database 124. Sharing server 100 determines that the members belonging to such an enterprise cannot be disclosed to the searcher. Sharing server 100 extracts members other than the members belonging to such an enterprise as members who can be disclosed to the searcher.

Next, sharing server 100 refers to member database 122A to exclude the profile information on the member whose profile information is set to non-disclosure from the extracted information on the member (step S216).

Next, sharing server 100 transmits the extracted information on the member to a search request source (step S217), and ends the process based on the flowchart. Recruiter apparatus 200 of the search request source receives the information on the member transmitted from sharing server 100, and displays the information on display 205. The information displayed on display 205 includes the extracted ID, name, and profile information on each member. Here, for a member whose profile information is not disclosed, only the ID and name of the member are displayed, and the profile information of the member is not displayed.

As described above, according to Modification 1, the recruiter can search for a member who is considered to be most suitable for application to the recruitment business while referring to the detailed profile information on the member, and can make a reverse offer to the member. In addition, members such as enterprises to which the recruiter belongs and enterprises in rival relation with the community are excluded from the members displayed as the search result. Therefore, it is possible to prevent the inconvenience of the recruiter ordering the business from members of such rival enterprises. Furthermore, since members themselves can determine whether or not to disclose the profile information, a system in which the free will of each member is respected can be provided.

A member may be allowed to set whether or not to disclose not only the profile information but also the name. Further, several categories may be provided for the profile information, and the member may be allowed to set whether or not to disclose the profile information for each category.

By adding the offer function described above to matching system 1, the recruiter can check the profile information on the member who is allowed to browse the recruitment case. Further, the recruiter can urge the members, to whom the recruiter wants to place an order, to apply. The member who is urged to apply by the recruiter can browse the case information and accept or reject the case. Further, each member can determine whether or not to disclose the profile information at the time of registering the member information, editing the member information, or the like. Thus, the recruiter can actively select an offer destination and make the most suitable applicant engage in the business at an early stage.

### Modification 2

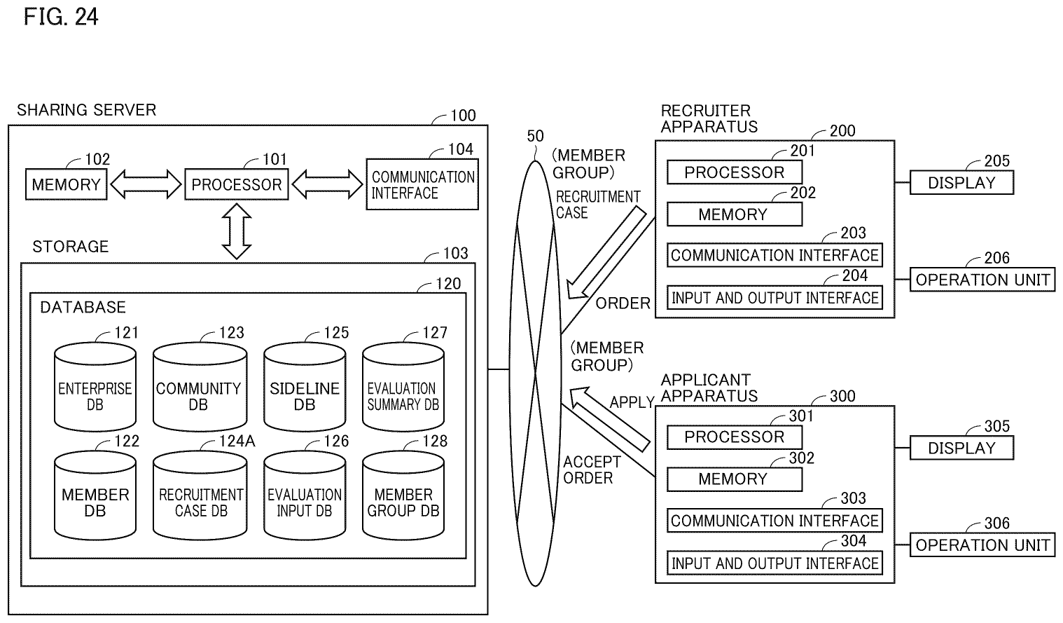

Next, a second modification will be described with reference to FIGS. 24 to 28. According to Modification 2, a member group application function will be described in which a plurality of members can apply for the recruitment business as a group.

### Background of Proposing Member Group Application Function

In crowdsourcing, generally, a recruiter discloses information on a recruitment case, and an individual who is interested in the content of the recruitment case applies for the recruitment. However, there are many cases that should be handled by a team of a plurality of persons, and many cases that are desirably handled by a team, such as a comprehensive business from business planning to acquisition of intellectual property rights related to the planning. Therefore, when the number of persons to be recruited is limited to one, it is difficult for a person who desires to accept an order to undertake more businesses than what can be handled by an individual.

In view of such a background, Modification 2 provides a member group application function that allows a plurality of members to apply for a recruitment business as a group. Modification 2 will be described in detail below.

FIG. 24 is a block diagram illustrating a configuration of sharing server 100, recruiter apparatus 200, and applicant apparatus 300 according to Modification 2. In the block diagram illustrated in FIG. 24, a member group database 128 is added as compared with the block diagram illustrated in FIG. 2. Recruitment case database 124A illustrated in FIG. 24 is obtained by adding a function of registering a recruitment case that allows application by a member group to recruitment case database 124 illustrated in FIG. 6.

A member group consisting of a plurality of members is registered in member group database 128. The recruiter can register a recruitment case that allows an application by a member group in recruitment case database 124A using recruiter apparatus 200. Applicants can apply as a member group registered in member group database 128 for the recruitment case which allows an application by the member group using applicant apparatus 300.

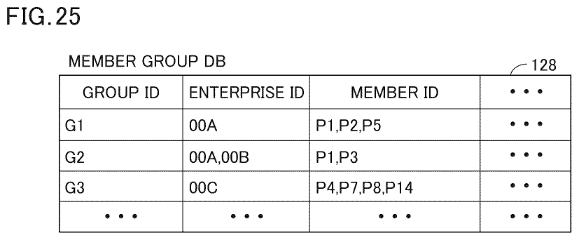

FIG. 25 is a diagram illustrating an example of member group database 128 according to Modification 2. Information on a member group is registered in member group database 128. The information on the member group includes a group ID for identifying the member group, an enterprise ID of an enterprise to which each member of the member group belongs, a member ID of each member of the member group, and the like.

Hereinafter, the member groups corresponding to each group ID may be referred to as member group G1, member group G2, member group G3 . . . using the group IDs.

Member group G1 is constituted of three members identified by member IDs=P1, P2, and P5. Since the enterprise ID registered in association with member group G1 is 00A, it is understood that all of the three members belong to enterprise A.

Member group G2 is constituted of two members identified by member IDs=P1 and P3. Since the enterprise IDs registered in association with member group G2 are 00A and 00B, it is understood that one of the two members belongs to enterprise A and the other belongs to enterprise B. As can be understood by comparing member group G1 and member group G2, member ID=P1 is registered in both member groups G1 and G2. Therefore, member P1 belongs to two member groups.

Member group G3 is constituted of four members identified by member IDs=P4, P7, P8, and P14. Since the enterprise ID registered in association with member group G3 is 00C, it is understood that all of the four members belong to enterprise C.

As illustrated in FIG. 24, member group database 128 is stored in storage 103 of sharing server 100. The member obtains consent from other members who have known the member through the same enterprise or community, etc. to form a member group, and registers the member group in member group database 128. The “member group” is an example of “application group”.

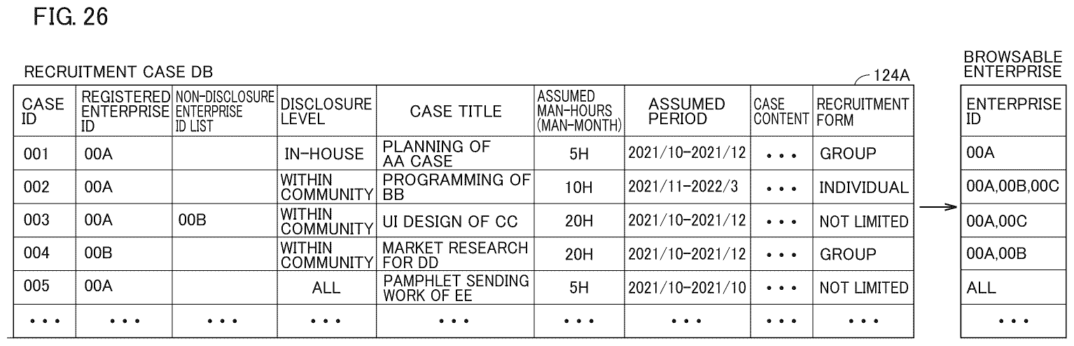

FIG. 26 is a diagram illustrating an example of recruitment case database 124A according to Modification 2. Recruitment case database 124A illustrated in FIG. 26 is different from recruitment case database 124 illustrated in FIG. 6 in that information on a recruitment form is added. The recruiter operates recruiter apparatus 200 to set the recruitment form. Sharing server 100 registers the recruitment form based on the setting in recruitment case database 124A in association with the business information.

The recruiter can select a recruitment form from a group form and an individual form. It is considered that when the recruiter does not select a recruitment form, the recruitment form of the recruitment case is not limited to the group form or the individual form. A case for which the recruitment form is set to be the group form can be ordered only by a member group. A case for which the recruitment form is set to be the individual form can be ordered only by an individual member. The case for which the recruitment form is not limited can be ordered by either a member group or an individual. The “information on the recruitment form” is an example of “information that can be used to identify that the business for which a vendor is recruited is to be jointly applied for by a plurality of recruiters.”

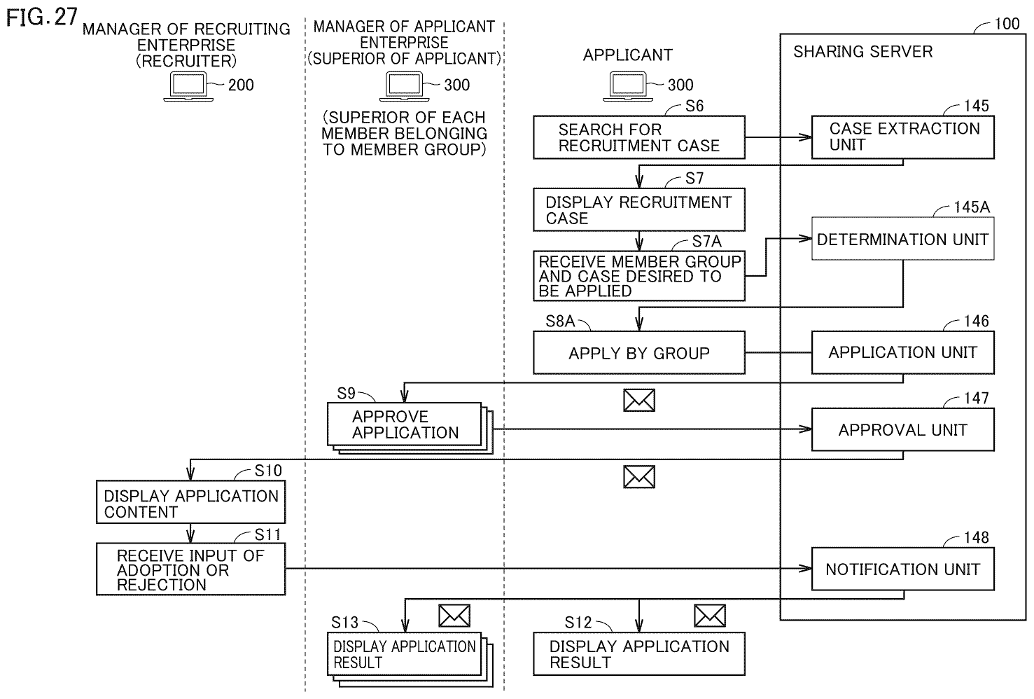

FIG. 27 is a diagram for illustrating functions of sharing server 100, recruiter apparatus 200, and applicant apparatus 300 according to Modification 2. In FIG. 27, a determination unit 145A is added to sharing server 100, compared to FIG. 11. In FIG. 27, step S7A is added after step S7, and step S8A for group application is adopted instead of step S8 for application, compared to FIG. 11.

Here, it is assumed that the applicant belongs to a plurality of member groups. The applicant operates applicant apparatus 300 to search for a recruitment case (step S6). Applicant apparatus 300 transmits the search request to case extraction unit 145 of sharing server 100.

When case extraction unit 145 receives the search request, as described with reference to FIG. 11, case extraction unit 145 extracts cases allowed to be browsed by the applicant from the recruitment cases registered in recruitment case database 124. The cases extracted by case extraction unit 145 include cases whose recruitment form is any of “group,” “individual,” and “not limited.” Case extraction unit 145 transmits the extracted recruitment cases to applicant apparatus 300. Applicant apparatus 300 receives the recruitment cases from case extraction unit 145. Applicant apparatus 300 displays the received recruitment cases on display 305 (step S7).

Display 305 displays, for each of the recruitment cases, a disclosure level, a case title, assumed man-hours, an assumed period, a case content, a recruitment form, and the like. When the applicant desires to apply as a member group, the applicant designates the member group and selects the case whose application form is “group” or “not limited” using operation unit 306 such as a mouse and a keyboard. Applicant apparatus 300 receives the member group and the case desired to be applied for based on the operation of the applicant (step S7A). Applicant apparatus 300 transmits the group ID of the received member group and the case ID of the received case to sharing server 100. Determination unit 145A of sharing server 100 acquires the group ID and the case ID.

Determination unit 145A accesses member group database 128 and identifies the member ID registered in association with the acquired group ID. Determination unit 145A accesses member database 122 and identifies the enterprise ID corresponding to the identified member ID.

Determination unit 145A accesses community database 123 and identifies the community ID of the community to which the enterprise with the identified enterprise ID belongs. Determination unit 145A accesses recruitment case database 124A, and identifies the enterprise ID (the enterprise ID of the recruiter), the non-disclosure enterprise IDs, the disclosure level, and the recruitment form registered in association with the acquired case ID.

Determination unit 145A determines whether or not the recruitment case received by applicant apparatus 300 is a case for which an application by the member group designated by the applicant is allowed, based on the information identified as described above. In other words, determination unit 145A determines whether or not to allow the application by the member group.

For example, determination unit 145A does not allow the application by the member group when one of the members in the member group belongs to an enterprise listed in the non-disclosure enterprise ID list corresponding to the recruitment case. Alternatively, determination unit 145A does not allow the application by the member group when one of the members in the member group belongs to an enterprise outside the community even though the disclosure level of the recruitment case is “within community”.

Determination unit 145A returns the determination result to applicant apparatus 300. FIG. 27 shows a flow in a case when determination unit 145A allows the application by the member group. When determination unit 145A allows the application by the member group, applicant apparatus 300 receives the application by the member group (step S8A). For example, applicant apparatus 300 displays, on display 305, a screen indicating that the application received in step S7A is allowed and a screen for checking whether or not to apply. The applicant selects an application using operation unit 306 such as a mouse and a keyboard.

When applicant apparatus 300 receives the application by the member group (step S8A), applicant apparatus 300 transmits the application information to sharing server 100. Application unit 146 of sharing server 100 acquires the application information. The contents of the subsequent processes are the same as the contents described with reference to FIG. 11. Here, application unit 146 transmits the application information to the superior of each member belonging to the member group. Therefore, the application approval process of step S9 is executed for each superior of each member belonging to the member group. Therefore, approval unit 147 receives approval information indicating approval of the application of the subordinate or rejection information indicating rejection of the application of the subordinate from a plurality of superiors.

Approval unit 147 accepts the application of the applicant only when approval information is obtained from all of the superiors of the members belonging to the member group. Approval unit 147 which has accepted the application of the applicant transmits application information to recruiter apparatus 200. As already described with reference to FIG. 11, recruiter apparatus 200 displays the application contents on display 205 (step S10). The recruiter inputs the result of the determination of adoption or rejection to recruiter apparatus 200. Recruiter apparatus 200 receives the input result (step S11), and transmits the received result of adoption or rejection to notification unit 148 of sharing server 100.

Notification unit 148 transmits the application result (the result of adoption or rejection) to applicant apparatus 300 of the applicant and applicant apparatus 300 of the superior (manager). Here, notification unit 148 transmits the application result to the superior of each member belonging to the member group.

Applicant apparatus 300 of the applicant and applicant apparatus 300 of the superior of each member belonging to the member group display the application result on display 305 (step S12, step S13). The applicant and the superior of each member belonging to the member group check the application result by viewing the display on display 305.

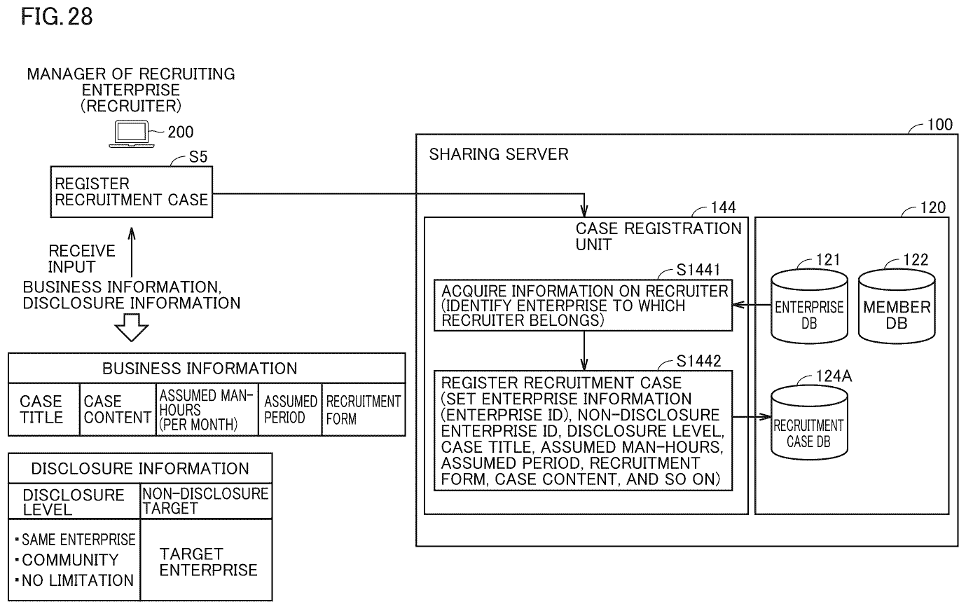

FIG. 28 is a diagram for illustrating a procedure of registering a recruitment case in recruitment case database 124A according to Modification 2. In FIG. 28, a recruitment form is added to the business information input to recruiter apparatus 200, as compared with FIG. 13.

According to Modification 2, when the recruiter who registers the recruitment case inputs the business information and the disclosure information on the recruitment case to recruiter apparatus 200, the recruitment form of the recruitment case can be included in the business information. The recruitment form is either the group form or the individual form. Case registration unit 144 of sharing server 100 registers the recruitment case including the recruitment form selected by the recruiter in recruitment case database 124A (step S1442). When the recruiter does not select the recruitment form, case registration unit 144 registers information indicating that the recruitment form is not limited in recruitment case database 124A. The other contents illustrated in FIG. 28 are the same as those in FIG. 13 that are already described, and therefore, the description thereof will not be repeated here.

As described above, according to Modification 2, a plurality of members can apply for a recruitment case as a group. Moreover, according to Modification 2, it is determined whether or not to allow the application of the member group based on the relation between the enterprise and the community to which the recruiter belongs and the enterprise and the community to which each member of the member group belongs. Therefore, it is possible to prevent a member group including a member belonging to an organization in a competitive relation with the applicant from receiving an order for the recruitment case of the applicant.

By adding the member group application function described above to matching system 1, it is possible to provide a system in which the vendor side can browse the recruitment case and apply for the recruitment case by the member group. Thus, matching system 1 can handle the placement and acceptance of orders of a large-scale business that is desirably handled by a team.

### Modification 3

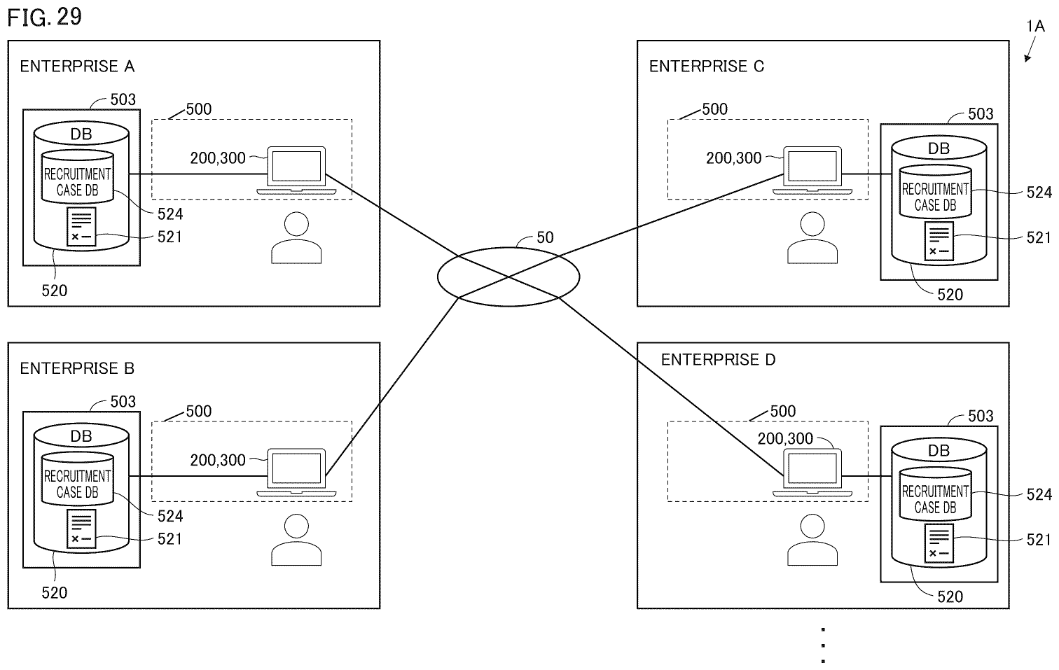

FIG. 29 is a diagram illustrating a configuration of a matching system 1A according to Modification 3. As illustrated in FIG. 29, the functions of sharing server 100 may be distributed and arranged in the system of each enterprise. That is, as matching system 1, matching system 1A which is managed in a decentralized manner may be adopted instead of matching system 1 which is managed in a centralized manner.

The system configuration illustrated in FIG. 29 is common in enterprises A, B, C, D . . . . A user device 500, a database 520, and a storage 503 for storing the database are arranged in each enterprise. When the member operates user device 500 as a recruiter, user device 500 functions as recruiter apparatus 200. When the member operates user device 500 as an applicant, user device 500 functions as applicant apparatus 300. Hereinafter, the member may be referred to as “user”.

User device 500 includes, for example, a server. User device 500 is an example of a computing apparatus that includes recruiter apparatus 200 and applicant apparatus 300. User device 500 includes a processor, a memory for storing a program or the like for arithmetic processing of the processor, a communication interface, and the like, similarly to recruiter apparatus 200 and applicant apparatus 300.

Database 520 has the function of database 120 illustrated in FIG. 2, and includes a recruitment case database 524 in place of recruitment case database 124, and other various databases. Recruitment cases created by employees, etc. of enterprise A as recruiters are registered in recruitment case database 524 of enterprise A. Recruitment cases created by employees, etc. of enterprise B as recruiters are registered in recruitment case database 524 of enterprise B. The recruitment cases created by employees, etc. of other enterprises as recruiters are also registered in recruitment case database 524 of other enterprises.

A disclosure permission list 521 is registered in database 520. Disclosure permission list 521 includes a list of groups (enterprises, communities, etc.) to which disclosure of the recruitment case is allowed. Disclosure permission list 521 includes information corresponding to the “non-disclosure enterprise ID list” and the “disclosure level” among the information registered in recruitment case database 124 illustrated in FIG. 6. User device 500 registers the recruitment case (business information) and disclosure permission list 521 (disclosure information) indicating the disclosure range of the recruitment case in database 520.

User device 500 of enterprise A determines enterprises or communities to which the recruitment case is disclosed and enterprises or communities to which the recruitment case is not disclosed based on disclosure permission list 521. User device 500 of enterprise A transmits the recruitment case to each enterprise or each community based on the determination. For example, when user device 500 of enterprise A determines that a recruitment case is disclosed to enterprise C and is not disclosed to enterprises B and D, user device 500 transmits the recruitment case to enterprise C and does not transmit the recruitment case to enterprises B and D.

User device 500 of each of enterprises B, C, D . . . also operates based on disclosure permission list 521, similarly to user device 500 of enterprise A. Thus, user device 500 determines the recruitment cases allowed to be disclosed to the applicant among the recruitment cases registered in database 520 based on disclosure permission list 521, and provides the recruitment cases allowed to be disclosed to the applicant to applicant apparatus 300.

According to Modification 3, it is not required to provide a server for managing the system in a centralized manner in the matching system.

### Modification 4

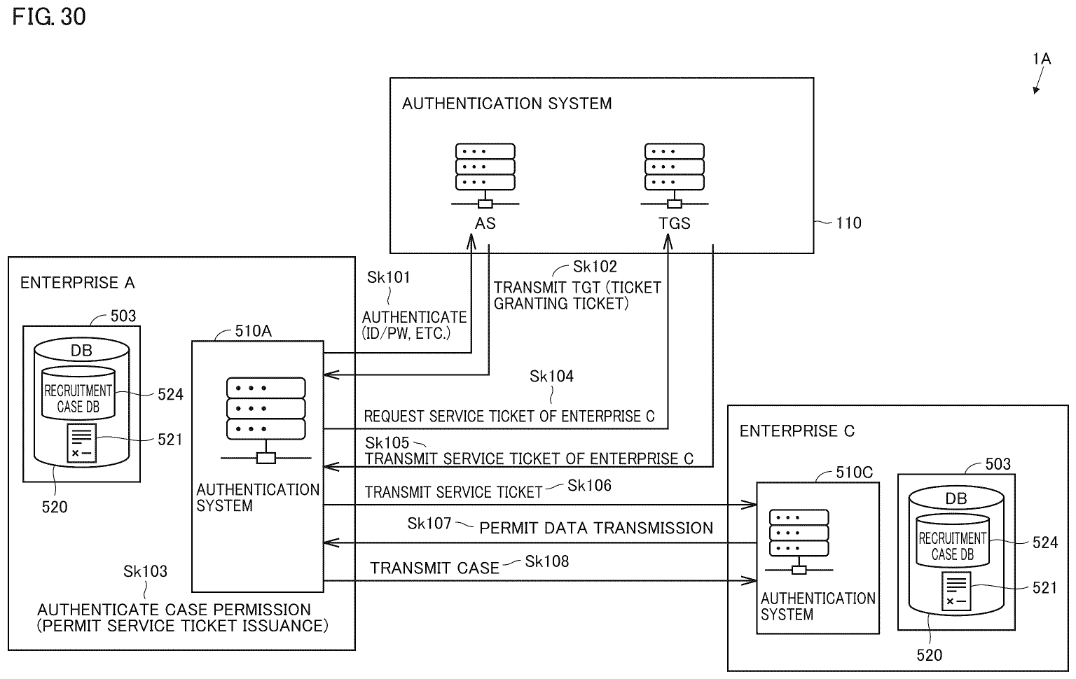

Modification 4 will be described with reference to FIG. 30. FIG. 30 is a diagram illustrating an example (Modification 4) of applying Kerberos authentication to matching system 1A. As illustrated in FIG. 30, Kerberos authentication may be applied to authentication among enterprises in matching system 1A. Kerberos authentication is one of network authentication schemes applied between a server and a client.

Here, Modification 3 will be described by taking enterprises A and C as examples among a plurality of enterprises. As illustrated in FIG. 30, an authentication system 510A is arranged in enterprise A, and an authentication system 510C is arranged in enterprise C. An authentication system 110 is a key distribution center (KDC). Authentication system 110 is operated by, for example, an authentication organization. Authentication system 110 is constituted of a server arranged in the authentication organization. Authentication systems 510A and 510C are constituted of, for example, user device 500 (see FIG. 29).

Authentication system 110 has a function of issuing a ticket granting ticket (TGT). Authentication system 110 includes an authentication server (AS) and a ticket granting server (TGS). The AS issues the ticket granting ticket (TGT). The TGT is a ticket for acquiring a service ticket. The TGS issues the service ticket. Enterprise A can transmit data to enterprise C by acquiring the service ticket.

Here, an example in which enterprise A performs Kerberos authentication and then transmits a recruitment case to enterprise C will be described. Therefore, here, enterprise A is a recruiter, and enterprise C is an applicant. First, authentication system 510A requests authentication system 110 to perform an authentication procedure (step Sk101). For example, authentication system 510A transmits information for authentication, such as the ID and password for login, to the AS of authentication system 110. Authentication system 510A may use a public authentication key method for the authentication procedure.

The AS of authentication system 110 performs authentication based on the information received from authentication system 510A, and then transmits the TGT to authentication system 510A (step Sk102). Authentication system 510A performs permission authentication of the case and acquires permission to issue a service ticket (step Sk103).

Next, authentication system 510A requests the TGS of authentication system 110 to send a service ticket of enterprise C (step Sk104). At this time, authentication system 510A presents the TGT issued by the AS to the TGS. The TGS checks the TGT and then transmits the service ticket of enterprise C to authentication system 510A (step Sk105).

Next, authentication system 510A transmits the service ticket to authentication system 510C of enterprise C in order to acquire transmission permission from enterprise C (step Sk106). Authentication system 510C acquires the service ticket. Authentication system 510C transmits permission for data transmission to authentication system 510A (step Sk107).

Thereafter, authentication system 510A transmits to authentication system 510C the cases allowed to be disclosed to enterprise C according to disclosure permission list 521 among the recruitment cases registered in recruitment case database 524. Thus, enterprise A can allow the applicants of enterprise C to browse the recruitment cases of enterprise A. Instead of storing disclosure permission list 521 of own enterprise in each enterprise, disclosure permission list 521 of all the enterprises may be stored in authentication system 110. In this case, authentication system 110 has a function of determining the browsing authority of the recruitment case.

When Kerberos authentication is applied to matching system 1, enterprise A can simplify the authentication procedure when transmitting a case to another enterprise other than enterprise C by utilizing the acquired TGT. For example, when the user wants to transmit a case to enterprise D, authentication system 510A of enterprise A presents the acquired TGT and then requests the TGS to transmit a service ticket of enterprise D. When the TGT is not problematic, the TGS issues a service ticket of enterprise D to authentication system 510A.

By utilizing the above-described Kerberos authentication, a single sign on method can be implemented in matching system 1. As a result, for example, when data such as a recruitment case is transmitted from enterprise A to another enterprise, it is not required to perform authentication for each enterprise. Here, enterprises A and C are illustrated as an example of a plurality of enterprises. However, the above-described Kerberos authentication may be applied as an authentication method among a plurality of enterprises of three or more.

According to the present embodiment described above, the enterprise on the purchaser side can provide case information only to limited enterprises, and therefore, leakage of confidential information can be prevented. The vendor enterprise can receive case information from an enterprise whose reliability is guaranteed by matching systems 1 and 1A, and thus can obtain highly reliable case information.

According to the present embodiment, the recruiter can set a non-disclosure enterprise separately from the disclosure level (see FIG. 13). That is, according to the present embodiment, recruiter apparatus 200 receives an operation of inputting a target group (a non-disclosure enterprise) for which disclosure of business information is prohibited, and transmits information (“non-disclosure target” in “disclosure information”) which can be used to identify the received target group to sharing server 100. When the disclosure level is a level at which disclosure of business information to a target group is allowed (disclosure level), sharing server 100 still prohibits disclosure of business information to an applicant belonging to the target group (S1442). Therefore, according to the present embodiment, it is possible to individually set enterprises for which the disclosure of recruitment cases is to be restricted.

According to the present embodiment, the manager of the enterprise to which the employee belongs can check the contents of the business received by the employee, and therefore, leakage of confidential information can be prevented. Further, according to the present embodiment, the enterprise on the vendor side can grasp the main business hours and the sideline hours of the employee. Therefore, the enterprise on the vendor side can perform health management of the employee.

As described above, according to the present embodiment, it is possible to provide matching systems 1 and 1A that function as platforms of crowdsourcing. In order to find a more appropriate human resource by utilizing crowdsourcing, it is desirable to further expand the range of crowdsourcing, rather than limiting the range of crowdsourcing to a specific enterprise or a small number of enterprises. In this case, the interest relation between the recruiter who recruits the vendor for the business and the applicant who applies for the recruitment is considered. According to matching systems 1 and 1A of the present embodiment, it is possible to select an appropriate applicant in consideration of the interest relation between the recruiter and the applicant.

Sharing server 100 and user device 500 are an example of computing apparatuses that communicate with an applicant apparatus and can access a database. Sharing server 100 and user device 500 register business information and disclosure information indicating the disclosure range of the business information in databases 120, 520. Sharing server 100 and user device 500 determine the business information allowed to be disclosed to the applicant among the business information registered in databases 120, 520 based on the disclosure information and provide (transmit) the business information allowed to be disclosed to the applicant to applicant apparatus 300. Sharing server 100 and user device 500 determine whether or not to allow disclosure for each of the first applicant, the second applicant, and the third applicant in accordance with the disclosure level (step S1452A).

A plurality of disclosure levels including “same enterprise,” “community,” and “no limitation” is set in the disclosure information. The plurality of disclosure levels includes a first level and a second level. The first level (for example, “in-house”) corresponds to allowing disclosure of the business information to the first applicant belonging to the first group and prohibiting disclosure of the business information to an applicant not belonging to the first group (see FIG. 19). The second level (for example, “within community”) corresponds to allowing disclosure of the business information to an applicant belonging to either the first group or a community group having a community relation formed with the first group, and prohibiting disclosure of the business information to an applicant not belonging to either the first group or the community group (see FIG. 19). The third level corresponds to allowing disclosure of the business information to an applicant belonging to the first group and a specific community group different from the community group of the second level having a community relation formed with the first group, and prohibiting disclosure of the business information to an applicant not belonging to either the first group or the specific community group (see the modification of FIG. 19).

The plurality of disclosure levels includes a disclosure level (see FIG. 19) corresponding to allowing disclosure of the business information to an applicant regardless of the group to which the applicant belongs. Attribute data (community ID) that can be used to identify the community group is registered in databases 120, 520, and sharing server 100 and user device 500 identify an applicant who is allowed to disclose the business information based on the disclosure information and the attribute data.

After receiving an input of a target group for which disclosure of the business information is prohibited (an enterprise ID of a non-disclosure enterprise), sharing server 100 and user device 500 prohibit disclosure of the business information to an applicant belonging to the target group even when the disclosure level is a level at which disclosure of the business information to the target group is allowed.

Sharing server 100 receives a request for searching for information on a plurality of registrants (members) registered in database 120 from recruiter apparatus 200 (step S21), and provides a search result based on the received request to the recruiter apparatus (step S22). Recruiter apparatus 200 receives an operation of selecting a recommended applicant who is recommended to apply as an applicant from the search result by the recruiter (step S23), and transmits identification information on the selected recommended applicant (the member ID of the member who is a target of reverse offer) to sharing server 100. Sharing server 100 transmits information for urging application to applicant apparatus 300 of the selected recommended applicant (step S24).

Sharing server 100 registers a plurality of pieces of profile information on each of a plurality of registrants (members) in database 120 described above (see FIG. 22). Sharing server 100 receives an input for setting a range to be disclosed as a search result among the plurality of pieces of profile information from each of the plurality of registrants (receives a setting operation on whether to allow disclosure for each type of profile information). Sharing server 100 receives an input of recruitment form information (recruitment form illustrated in FIG. 28) that can be used to identify whether the business for which a vendor is recruited is a group business for which an order can be accepted when a plurality of applicants jointly apply or a business for which an order can be accepted in response to an application by a single applicant. Sharing server 100 registers the recruitment form information in database 120 in association with the business information (step S1442).

Sharing server 100 registers an application group (member group) constituted of a plurality of applicants in database 120. Sharing server 100 receives an application by the application group for the business information that is allowed to be disclosed to all the applicants belonging to the application group (determination unit 145A).

### Aspects

Aspects of the present disclosure are listed below.

(Aspect 1) A matching system according to Aspect 1 matches an applicant with a recruiter who recruits a vendor for a business, the matching system including: a first applicant apparatus that is operated by a first applicant; and a computing apparatus that communicates with the first applicant apparatus and is accessible to a database, in which the computing apparatus is configured to register, in the database, business information for recruiting the vendor and disclosure information indicating a disclosure range of the business information, and the computing apparatus is configured to determine, based on the disclosure information, business information allowed to be disclosed to the first applicant among the business information registered in the database and to provide the business information allowed to be disclosed to the first applicant to the first applicant apparatus.

(Aspect 2) A matching system according to Aspect 2 is the matching system according to Aspect 1, further including: a recruiter apparatus that is operated by the recruiter, in which the recruiter apparatus is configured to transmit the business information and the disclosure information to the computing apparatus.

(Aspect 3) A matching system according to Aspect 3 is the matching system according to Aspect 1, in which the computing apparatus includes a recruiter apparatus that is operated by the recruiter.

(Aspect 4) A matching system according to Aspect 4 is the matching system according to any one of Aspects 1 to 3, further including: a second applicant apparatus that is operated by a second applicant different from the first applicant, in which the computing apparatus is configured to determine, based on the disclosure information, business information allowed to be disclosed to the second applicant among the business information registered in the database, and configured to provide the business information allowed to be disclosed to the second applicant to the second applicant apparatus.

(Aspect 5) A matching system according to Aspect 5 is the matching system according to Aspect 4, further including: a third applicant apparatus that is operated by a third applicant different from the first applicant and the second applicant, in which a plurality of disclosure levels is set in the disclosure information, and the computing apparatus is configured to determine whether or not to allow disclosure respectively to the first applicant to the third applicant in accordance with the disclosure level.

(Aspect 6) A matching system according to Aspect 6 is the matching system according to Aspect 5, in which the first applicant belongs to a first group, the second applicant belongs to a second group different from the first group, the plurality of disclosure levels includes a first level and a second level, the first level corresponds to allowing disclosure of the business information to the first applicant and prohibiting disclosure of the business information to an applicant who does not belong to the first group, and the second level corresponds to allowing disclosure of the business information to an applicant who belongs to the first group or a community group having a community relation formed with the first group and prohibiting disclosure of the business information to an applicant who does not belong to either the first group or the community group.

(Aspect 7) A matching system according to Aspect 7 is the matching system according to Aspect 5, in which the first applicant belongs to a first group, the second applicant belongs to a second group different from the first group, the plurality of disclosure levels includes a first level, a second level, and a third level, the first level corresponds to allowing disclosure of the business information to the first applicant and prohibiting disclosure of the business information to an applicant who does not belong to the first group, the second level corresponds to allowing disclosure of the business information to an applicant who belongs to the first group or a community group having a community relation formed with the first group, and the third level corresponds to allowing disclosure of the business information to an applicant who belongs to the first group and a specific community group different from the community group of the second level having the community relation formed with the first group and prohibiting disclosure of the business information to an applicant who does not belong to either the first group or the specific community group.

(Aspect 8) A matching system according to Aspect 8 is the matching system according to Aspect 6, in which the plurality of disclosure levels includes a disclosure level corresponding to allowing disclosure of the business information to an applicant regardless of a group to which the applicant belongs.

(Aspect 9) A matching system according to Aspect 9 is the matching system according to any one of Aspects 6 to 8, in which an attribute data which can be used to identify the community group is registered in the database, and the computing apparatus is configured to identify an applicant for whom disclosure of the business information is allowed based on the disclosure information and the attribute data.

(Aspect 10) A matching system according to Aspect 10 is the matching system according to any one of Aspects 5 to 7, in which the recruiter apparatus receives an operation of inputting a target group for which disclosure of the business information is prohibited, and transmits information that can be used to identify the target group which has been received to the computing apparatus, and the computing apparatus is still configured to prohibit disclosure of the business information to an applicant who belongs to the target group even when the disclosure level is a level at which disclosure of the business information to the target group is allowed.

(Aspect 11) A matching system according to Aspect 11 is the matching system according to any one of Aspects 4 to 10, in which the first applicant belongs to a first enterprise, and the second applicant belongs to a second enterprise different from the first enterprise.

(Aspect 12) A matching system according to Aspect 12 is the matching system according to Aspect 2, in which the computing apparatus is configured to receive a request for searching for information on a plurality of registrants registered in the database from the recruiter apparatus and to provide a search result based on the request which has been received to the recruiter apparatus, the recruiter apparatus is configured to receive an operation of selecting a recommended applicant who is recommended to apply as an applicant from the search result by the recruiter and to transmit identification information on the recommended applicant who has been selected to the computing apparatus, and the computing apparatus is configured to transmit information for urging application to the applicant apparatus of the recommended applicant who has been selected.

(Aspect 13) A matching system according to Aspect 13 is the matching system according to Aspect 12, in which the computing apparatus is configured to register a plurality of pieces of profile information on each of the plurality of registrants in the database, and the computing apparatus is configured to receive an input for setting a range to be disclosed as the search result among the plurality of pieces of profile information from each of the plurality of registrants.

(Aspect 14) A matching system according to Aspect 14 is the matching system according to any one of Aspects 1 to 13, in which the recruiter apparatus is configured to transmit recruitment form information, which can be used to identify whether a business for which the vendor is recruited is a group business for which an order is acceptable when a plurality of applicants jointly apply or a business for which an order is acceptable in response to an application by a single applicant, to the computing apparatus, and the computing apparatus is configured to register the recruitment form information in the database in association with the business information.

(Aspect 15) A matching system according to Aspect 15 is the matching system according to Aspect 14, in which the computing apparatus is configured to register an application group constituted of a plurality of applicants in the database, and the computing apparatus can receive an application by the application group for business information that is allowed to be disclosed to all applicants belonging to the application group.

(Aspect 16) A recruiter apparatus according to Aspect 16 communicates with a computing apparatus that matches an applicant with a recruiter who recruits a vendor for a business and is operated by the recruiter, the recruiter apparatus including: an interface that receives an operation of inputting business information and disclosure information indicating a disclosure range of the business information; and a processor that transmits to the computing apparatus, the business information and the disclosure information received by the interface, in which the disclosure information includes information that commands the computing apparatus to allow disclosure of the business information to a first applicant and to prohibit disclosure of the business information to a second applicant different from the first applicant.

(Aspect 17) A method according to Aspect 17 is for matching an applicant with a recruiter who recruits a vendor for a business, the method including: communicating with a first applicant apparatus operated by a first applicant; registering business information for recruiting the vendor and disclosure information indicating a disclosure range of the business information in a database; and determining, based on the disclosure information, business information allowed to be disclosed to the first applicant among the business information registered in the database to provide the business information allowed to be disclosed to the first applicant to the first applicant apparatus.

It should be understood that the embodiments disclosed herein are illustrative in all respects and are not restrictive. The scope of the present invention is defined not by the above description of the embodiments but by the claims, and is intended to include all modifications within the meaning and scope equivalent to the claims.

### REFERENCE SIGNS LIST

1: matching system, 50: internet, 100: sharing server, 101: processor, 102: memory, 103, 503: storage, 104: communication interface, 120, 520: database (DB), 121: enterprise database (enterprise DB), 122, 122A: member database (member DB), 123: community database (community DB), 124, 124A, 524: recruitment case database (recruitment case DB), 125: sideline database (sideline DB), 126: evaluation input database (evaluation input DB), 127: evaluation summary database (evaluation summary DB), 127A, 127B: data group, 128: member group database (member group DB), 140: community registration unit, 141: enterprise registration unit, 142: member registration unit, 143: member search unit, 144: case registration unit, 145: case extraction unit, 145A: determination unit, 146: application unit, 147: approval unit, 148: notification unit, 149: achievement receiving unit, 150: achievement output unit, 151: evaluation receiving unit, 152: evaluation output unit, 161: reverse offer request unit, 162: reverse offer approval request unit, 163: reverse offer request acceptance notification unit, 200, 200A, 200B, 200C: recruiter apparatus, 201: processor, 202: memory, 203: communication interface, 204: input and output interface, 205: display, 206: operation unit, 206A: keyboard, 206B: mouse, 207: screen, 300, 300A, 300B, 300C: applicant apparatus, 301: processor, 302: memory, 303: communication interface, 304: input and output interface, 305: display, 306: operation unit, 306A: keyboard, 306B: mouse, 307A to 307C: tab, 401, 402: table, 500: user device, 521: disclosure permission list.

1. A matching system that matches an applicant with a recruiter who recruits a vendor for a business, the matching system comprising:
a first applicant apparatus that is operated by a first applicant; and
a computing apparatus that is configured to:
communicate with the first applicant apparatus;
access a database;
register, in the database, business information for recruiting the vendor and disclosure information indicating a disclosure range of the business information;
determine, based on the disclosure information, business information allowed to be disclosed to the first applicant among the business information registered in the database;
provide the determined business information to the first applicant apparatus;
receive an input of recruitment form information;
register the recruitment form information in the database in association with the business information, the recruitment form information being for identifying whether a business for which the vendor is recruited is a group business for which an order is acceptable when a plurality of applicants jointly apply or a business for which an order is acceptable in response to an application by a single applicant;
register an application group comprising a plurality of applicants in the database; and
receive an application by the application group for business information that is allowed to be disclosed to all applicants belonging to the application group.

2. The matching system according to claim 1, further comprising:
a recruiter apparatus that is operated by the recruiter,
wherein the recruiter apparatus is configured to transmit the business information and the disclosure information to the computing apparatus.

3. The matching system according to claim 1, further comprising:
a second applicant apparatus that is operated by a second applicant that is different from the first applicant,
wherein the computing apparatus is configured to:
determine, based on the disclosure information, business information allowed to be disclosed to the second applicant among the business information registered in the database, and
provide the business information allowed to be disclosed to the second applicant to the second applicant apparatus.

4. The matching system according to claim 3, further comprising:
a third applicant apparatus that is operated by a third applicant that is different from the first applicant and the second applicant,
wherein a plurality of disclosure levels is set in the disclosure information, and
wherein the computing apparatus is configured to determine whether or not to allow disclosure respectively to the first applicant, the second applicant, and the third applicant in accordance with the disclosure level.

5. The matching system according to claim 4, wherein when the computing apparatus has received an input of a target group for which disclosure of the business information is prohibited, the computing apparatus is configured to prohibit disclosure of the business information to an applicant who belongs to the target group in a case where the disclosure level is a level at which disclosure of the business information to the target group is allowed.

6. The matching system according to claim 4, wherein the first applicant belongs to a first enterprise and the second applicant belongs to a second enterprise different from the first enterprise.

7. The matching system according to claim 2,
wherein the computing apparatus is configured to receive a request for searching for information on a plurality of registrants registered in the database from the recruiter apparatus and to provide a search result based on the request which has been received to the recruiter apparatus,
wherein the recruiter apparatus is configured to receive an operation of selecting a recommended applicant who is recommended to apply as an applicant from the search result by the recruiter and to transmit identification information on the recommended applicant who has been selected to the computing apparatus, and
wherein the computing apparatus is configured to transmit information for urging application to the applicant apparatus of the recommended applicant who has been selected.

8. The matching system according to claim 7,
wherein the computing apparatus is configured to register a plurality of pieces of profile information on each of the plurality of registrants in the database, and
wherein the computing apparatus is configured to receive an input for setting a range to be disclosed as the search result among the plurality of pieces of profile information from each of the plurality of registrants.

9. A recruiter apparatus that communicates with a computing apparatus that matches an applicant with a recruiter who recruits a vendor for a business and is operated by the recruiter, the recruiter apparatus comprising:
an interface that is configured to receive an operation of inputting business information and disclosure information indicating a disclosure range of the business information; and
a processor that is configured to transmit to the computing apparatus, the business information and the disclosure information received by the interface,
wherein the disclosure information includes information that commands the computing apparatus to allow disclosure of the business information to a first applicant and to prohibit disclosure of the business information to a second applicant that is different from the first applicant,
wherein the computing apparatus is configured to:
receive an input of recruitment form information, the computing apparatus is configured to register the recruitment form information in the database in association with the business information, the recruitment form information being for identifying whether a business for which the vendor is recruited is a group business for which an order is acceptable when a plurality of applicants jointly apply or a business for which an order is acceptable in response to an application by a single applicant,
register an application group comprising a plurality of applicants in the database, and
receive an application by the application group for business information that is allowed to be disclosed to all applicants belonging to the application group.

10. A method for matching an applicant with a recruiter who recruits a vendor for a business, the method comprising:
communicating with a first applicant apparatus operated by a first applicant;
registering business information for recruiting the vendor and disclosure information indicating a disclosure range of the business information in a database;
determining, based on the disclosure information, business information allowed to be disclosed to the first applicant among the business information registered in the database to provide the business information allowed to be disclosed to the first applicant to the first applicant apparatus;
registering recruitment form information in the database in association with the business information when an input of the recruitment form information is received, the recruitment form information being for identifying whether a business for which the vendor is recruited is a group business for which an order is acceptable when a plurality of applicants jointly apply or a business for which an order is acceptable in response to an application by a single applicant;
registering an application group comprising a plurality of applicants in the database; and
receiving an application by the application group for business information that is allowed to be disclosed to all applicants belonging to the application group.

11. A matching system that matches an applicant with a recruiter who recruits a vendor for a business, the matching system comprising:
a first applicant apparatus that is operated by a first applicant;
a computing apparatus comprising a recruiter apparatus that is operated by the recruiter; and configured to:
communicate with the first applicant apparatus;
access a database;
register, in the database, business information for recruiting the vendor and disclosure information indicating a disclosure range of the business information;
determine, based on the disclosure information, business information allowed to be disclosed to the first applicant among the business information registered in the database; and
provide the determined business information to the first applicant apparatus.

12. A matching system that matches an applicant with a recruiter who recruits a vendor for a business, the matching system comprising:
a first applicant apparatus that is operated by a first applicant;
a second applicant apparatus that is operated by a second applicant different from the first applicant;
a third applicant apparatus that is operated by a third applicant different from the first applicant and the second applicant; and
a computing apparatus that is configured to:
communicate with the first applicant apparatus;
access a database;
register, in the database, business information for recruiting the vendor and disclosure information indicating a disclosure range of the business information and a plurality of disclosure levels;
determine, based on the disclosure information, business information allowed to be disclosed to the first applicant among the business information registered in the database;
provide the business information allowed to be disclosed to the first applicant to the first applicant apparatus;
determine, based on the disclosure information, business information allowed to be disclosed to the second applicant among the business information registered in the database;
provide the business information allowed to be disclosed to the second applicant to the second applicant apparatus; and
determine whether or not to allow disclosure respectively to the first applicant, the second applicant, and the third applicant in accordance with the disclosure level,
wherein the first applicant belongs to a first group and the second applicant belongs to a second group different from the first group, and
wherein the plurality of disclosure levels includes a first level corresponding to allowing disclosure of the business information to the first applicant and prohibiting disclosure of the business information to an applicant who does not belong to the first group, and includes a second level corresponding to allowing disclosure of the business information to an applicant who belongs to the first group or a community group having a community relation formed with the first group and prohibiting disclosure of the business information to an applicant who does not belong to either the first group or the community group.

13. A matching system that matches an applicant with a recruiter who recruits a vendor for a business, the matching system comprising:
a first applicant apparatus that is operated by a first applicant;
a second applicant apparatus that is operated by a second applicant different from the first applicant;
a third applicant apparatus that is operated by a third applicant different from the first applicant and the second applicant; and
a computing apparatus that is configured to:
communicate with the first applicant apparatus;
access a database;
register, in the database, business information for recruiting the vendor and disclosure information indicating a disclosure range of the business information and a plurality of disclosure levels;
determine, based on the disclosure information, business information allowed to be disclosed to the first applicant among the business information registered in the database;
provide the business information allowed to be disclosed to the first applicant to the first applicant apparatus;
determine, based on the disclosure information, business information allowed to be disclosed to the second applicant among the business information registered in the database;
provide the business information allowed to be disclosed to the second applicant to the second applicant apparatus; and
determine whether or not to allow disclosure respectively to the first applicant to the third applicant in accordance with the disclosure level,
wherein the first applicant belongs to a first group and the second applicant belongs to a second group different from the first group, and
wherein the plurality of disclosure levels includes a first level corresponding to allowing disclosure of the business information to the first applicant and prohibiting disclosure of the business information to an applicant who does not belong to the first group, a second level corresponding to allowing disclosure of the business information to an applicant who belongs to the first group or a community group having a community relation formed with the first group, and a third level corresponding to allowing disclosure of the business information to an applicant who belongs to the first group and a specific community group different from the community group of the second level having the community relation formed with the first group and prohibiting disclosure of the business information to an applicant who does not belong to either the first group or the specific community group.

14. The matching system according to claim 12, wherein the plurality of disclosure levels includes a level corresponding to allowing disclosure of the business information to an applicant regardless of a group to which the applicant belongs.

15. The matching system according to claim 12, further comprising:
an attribute data for identifying whether or not the community group is registered in the database,
wherein the computing apparatus is configured to identify an applicant for whom disclosure of the business information is allowed based on the disclosure information and the attribute data.
